(19) United States
(12) Patent Application Publication
(10) Pub. No.: US 2004/0059995 A1
(43) Pub. Date: Mar. 25, 2004

(54) Printing system and apparatus used therefor

(75) Inventors: Nobuhisa Takabayashi, Nagano-ken (JP); Mikiya Shimada, Sapporo-shi (JP); Atsushi Hatta, Paito-shi (JP); Masaru Hoshino, Suwa-shi (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/338,891

(22) Filed: Jan. 9, 2003

(30) Foreign Application Priority Data
Jan. 15, 2002 (JP) 2002-6061
Jan. 15, 2002 (JP) 2002-6062
Jan. 15, 2002 (JP) 2002-6063

(51) Int. Cl. G06F 15/00

(52) U.S. Cl. 715/500

(57) ABSTRACT

In response to selection of a desired paper material for printing among multiple paper materials settable in a printer, a system generates a print job and outputs the generated print job to a print job execution device, even when the selected paper material is not coincident with any of paper materials currently set in the printer. The print job execution device keeps the print job with the selected paper material, which is not currently set in the printer, in a standby state and executes the print job when the selected paper material is set in the printer.

### BACKGROUND OF THE INVENTION

1. Field of the Invention

The present invention relates to a printing system including a print job output device that outputs print jobs and a print job execution device that causes a printer to execute the print jobs, as well as to a print job output device and a print job execution device used in this system.

2. Description of the Prior Art

In printing systems that have become popular recently, a client computer reads each image photographed by a digital still camera, carries out retouching and layout edition of the image according to image processing software, and outputs a print job of printing the processed image to a print server via a communication line. The print server causes a printer to print the processed image on a preset paper material.

In such prior art printing systems, however, setting a desired paper material, which is different from a paper material currently set in the printer, for the print job output from the client computer may not be allowed. Even if it is allowed, the paper material currently set in the printer should be replaced immediately by the desired paper material set for the print job.

The print server receives print data, which have been converted from image data by the client computer, together with printing conditions. Only one printer is thus connectable with the print server. There is, of course, a technique that outputs received print jobs sequentially to multiple printers connected with the print server. This technique, however, does not allow for color correction adequate for each printer. When the print server receives multiple print jobs of printing an identical image, resulting prints output from different printers may thus have slightly different colors.

### SUMMARY OF THE INVENTION

The object of the present invention is thus to attain efficient output of print jobs. The object of the present invention is also to attain efficient processing of print jobs. The object of the present invention is further to attain execution of print jobs with multiple printers, which require different series of processing with regard to a print job.

In order to achieve at least a part of the aforementioned objects, printing system and apparatus and methods used therefore of the present invention are structured as follows.

A first printing system of the present invention is a printing system where a print job output device that outputs a print job is connected via a communication line with a print job execution device that is equipped with a printer,

the print job output device including: a storage module that stores information on multiple paper materials settable in the printer of the print job execution device as multiple settable paper materials and information on a paper material currently set in the printer of the print job execution device as a setting paper material; a paper material selection module that selects a printing paper material used for printing among the multiple settable paper materials; a print job generation module that generates a print job of printing object print data on the selected printing paper material, whether the printing paper material is coincident with or different from the currently set paper material; and a print job output module that outputs the generated print job to the print job execution device,

the print job execution device including: a setting paper material storage module that stores information on the paper material currently set in the printer as the setting paper material; a print job accept module that accepts the print job of printing the object print data on the printing paper material selected as the paper material used for printing, which is output from the print job output device; a print job holder module that holds the accepted print job as a currently processible print job in the case where the printing paper material selected for the print job is coincident with the setting paper material and holds the accepted print job as a currently non-processible print job in the case where the printing paper material selected for the print job is different from the setting paper material, the print job holder module, in response to a replacement of the setting paper material, holding a print job, which has a selected paper material coincident with the replaced setting paper material, among the print jobs held therein as a currently processible print job and holding a print job, which has a selected paper material different from the replaced setting paper material, among the print jobs held therein as a currently non-processible print job; and a print job execution module that causes the printer to execute the currently processible print job among the print jobs held in the print job holder module.

In the first printing system of the present invention, in response to selection of the printing paper material used for printing among the multiple settable paper materials, the print job output device generates a print job of printing object print data on the selected printing paper material and outputs the generated print job to the print job execution device, even when the printing paper material is different from the currently set paper material. The print job output device thus successively generates multiple print jobs having different printing paper materials and outputs the multiple print jobs to the print job execution device. This arrangement ensures efficient output of the print jobs. In the first printing system of the present invention, the print job execution device accepts the print job of printing the object print data on the selected printing paper material from the print job output device via the communication line. The print job execution device holds the accepted print job as a currently processible print job in the case where the printing paper material selected for the print job is coincident with the setting paper material, while holding the accepted print job as a currently non-processible print job in the case where the printing paper material selected for the print job is different from the setting paper material. The print job execution device can thus accept multiple print jobs having different printing paper materials. When the setting paper material in the printer is replaced, the print job execution device holds a print job, which has a selected paper material coincident with the replaced setting paper material, among the print jobs held therein as a currently processible print job, while holding a print job, which has a selected paper material different from the replaced setting paper material, among the print jobs held therein as a currently non-processible print job. The print job is thus automatically executed when the status of the print job is changed to processible. This arrangement ensures efficient execution of the print jobs.

As one aspect of the first printing system of the present invention, the print job generation module of the print job output device acquires status information, which includes information on the setting paper material currently set in the printer, from the print job execution device via the communication line, notifies incapable processing information representing that a print job to be generated is currently non-processible when the selected printing paper material is different from the setting paper material, and generates the print job in response to an approval for the notification of the incapable processing information. Further, the print job output device includes a paper material information acquisition module that acquires information on the multiple settable paper materials and the setting paper material from the print job execution device via the communication line, and the storage module stores the information on the multiple settable paper materials and the setting paper material acquired by the paper material information acquisition module. Moreover, the paper material selection module of the print job output device selects a paper size and a paper quality among the multiple settable paper materials on a layout editing window of the object print data, thereby selecting the printing paper material.

As another aspect of the first printing system of the present invention, the setting paper material storage module of the print job execution device updates the information on the setting paper material in response to every replacement of the setting paper material currently set in the printer. Further, the print job execution device includes a job status display module that displays a status of a print job held in the print job holder module. In this case, the job status display module of the print job execution device displays the printing paper material selected for the print job, in addition to the status of the print job. The job status display module of the print job execution device also displays the status of the print job that is currently being executed by the print job execution module, or updates information to be displayed at regular intervals.

A second printing system of the present invention is a printing system where a print job output device that outputs a print job is connected via a communication line with a print job execution device that has multiple printers, each printer accepting a preset number of print jobs having a printing condition coincident with a setting condition therein and successively executing the accepted print jobs,

the print job output device including: a storage module that stores information on multiple paper materials settable in the multiple printers of the print job execution device as multiple settable paper materials and information on a paper material currently set in each of the multiple printers of the print job execution device as a setting paper material; a paper material selection module that selects a printing paper material used for printing among the multiple settable paper materials; a print job generation module that generates a print job of printing object print data on the selected printing paper material, whether the printing paper material is coincident with or different from any setting paper material; and a print job output module that outputs the generated print job to the print job execution device,

the print job execution device including: a job input module that inputs print jobs having printing conditions; an accepted job number detection module that detects a number of print jobs accepted by each of the multiple printers; a condition storage module that stores a setting condition set in each of the multiple printers; and a job distribution module that distributes a certain print job, which has not yet been accepted by any of the multiple printers, among the print jobs input by the job input module, to one of the multiple printers for acceptance, based on the numbers of print jobs accepted respectively by the multiple printers and detected by the accepted job number detection module, the setting conditions set respectively in the multiple printers and stored in the condition storage module, and the printing condition of the certain print job input by the job input module.

In the second printing system of the present invention, in response to selection of the printing paper material used for printing among the multiple settable paper materials, the print job output device generates a print job of printing object print data on the selected printing paper material and outputs the generated print job to the print job execution device, even when the printing paper material is different from the currently set paper material. The print job output device thus successively generates multiple print jobs having different printing paper materials and outputs the multiple print jobs to the print job execution device. This arrangement ensures efficient output of the print jobs. In the second printing system of the present invention, each of the multiple printers accepts a preset number of print jobs having a printing condition that is coincident with a setting condition in the printer and successively executes the preset number of print jobs. The print job execution device distributes a certain print job, which has not yet been accepted by any of the multiple printers, among the input print jobs, to one of the multiple printers for acceptance, based on the numbers of print jobs accepted respectively by the multiple printers, the setting conditions set respectively in the multiple printers, and the printing condition of the input certain print job. This arrangement enables the input print jobs to be executed efficiently by the multiple printers.

As one aspect of the second printing system of the present invention, the print job generation module of the print job output device acquires status information, which includes information on the setting paper material currently set in the printer, from the print job execution device via the communication line, notifies incapable processing information representing that a print job to be generated is currently non-processible when the selected printing paper material is different from the setting paper material, and generates the print job in response to an approval for the notification of the incapable processing information. Further, the print job output device includes a paper material information acquisition module that acquires information on the multiple settable paper materials and the setting paper material from the print job execution device via the communication line, and the storage module stores the information on the multiple settable paper materials and the setting paper material acquired by the paper material information acquisition module. Moreover, the paper material selection module of the print job output device selects a paper size and a paper quality among the multiple settable paper materials on a layout editing window of the object print data, thereby selecting the printing paper material.

As another aspect of the second printing system of the present invention, the job distribution module of the print job execution device distributes the certain print job, when any of the numbers of print jobs accepted respectively by the multiple printers and detected by the accepted job number detection module is less than the preset number. Further, the job distribution module of the print job execution device distributes the certain print job to a printer having a less number of the accepted print jobs, when the setting conditions set in plural printers are coincident with the printing condition of the certain print job. Moreover, the print job execution device includes a job processing status output module that outputs each of the print jobs input by the job input module in a discriminative manner to allow discrimination among a print job in a status of not being accepted by any of the multiple printers, a print job in a status of being accepted by any of the multiple printers but not being executed, a print job in a status of being currently executed by any of the multiple printers, and a print job in a status of completed execution by any of the multiple printers. In addition, the print job execution device includes a distribution reservation module that reserves the distribution of a specific print job by the job distribution module until a setting condition coincident with the printing condition is set in any of the multiple printers, in the case where the printing condition of the specific print job input by the job input module is not coincident with any of the setting conditions set respectively in the multiple printers and stored in the condition storage module. In this case, the print job execution device includes a job processing status output module that outputs each of the print jobs input by the job input module in a discriminative manner to allow discrimination among a print job in a status of not being accepted by any of the multiple printers, a print job in a status of being accepted by any of the multiple printers but not being executed, a print job in a status of being currently executed by any of the multiple printers, a print job in a status of completed execution by any of the multiple printers, and a print job in a status of reserved distribution by the distribution reservation module. As one preferable application, the job input module of the print job execution device inputs the print job with specification of a printer to execute printing among the multiple printers as one of printing conditions, and the job distribution module of the print job execution device distributes the print job with specification of the printer to execute printing as one of printing conditions to the specified printer. As another preferable application, the print job execution device includes a job processing status change module that changes a print job in a status of completed execution by any of the multiple printers to a print job in a status of not being accepted by any of the multiple printers. As still another preferable application, each of the multiple printers included in the print job execution device accepts and successively executes print jobs, which have been subjected to a printing process of converting image data into print data printable by the printer, and the job distribution module of the print job execution device makes the certain print job subjected to the printing process, prior to distribution. In this case, the print job execution device further includes a color correction data storage module that stores color correction data with regard to each of the multiple printers, and the job distribution module of the print job execution device carries out color correction of the image data, as one of the printing process, with color correction data of the printer to which the certain print job is distributed, among the color correction data stored in the color correction data storage module.

The present invention is not restricted to the first printing system or the second printing system discussed above. The present invention is also directed to print job output devices and print job execution devices used in the first printing system and in the second printing system. Other possible applications include a method of outputting a print job from the print job output device included in the first printing system or in the second printing system, as well as a method of causing a print job to be executed by the print job execution device included in the first printing system and a method of causing a print job to be executed by the print job execution device included in the second printing system.

### BRIEF DESCRIPTION OF THE DRAWINGS

FIG. 1 schematically illustrates the construction of a photo studio system in one embodiment;

FIG. 2 is a flowchart showing a layout editing routine executed by a client;

FIG. 3 shows a layout editing window;

FIG. 4 shows display of a dialog box on the layout editing window;

FIG. 5 is a flowchart showing a printing instruction receiving routine executed by a print server;

FIG. 6 is a flowchart showing a printing instruction execution routine executed by the print server;

FIG. 7 is a flowchart showing a setting paper material information updating routine executed by the print server;

FIG. 8 is a flowchart showing a printer monitor processing routine executed by the client;

FIG. 9 shows a printer monitor window;

FIG. 10 is a flowchart showing a printer monitor processing routine executed by the print server;

FIG. 11 is a block diagram showing functional blocks of a print server 130 included in in a printing system 110 of a second embodiment;

FIG. 12 is a flowchart showing a print job input routine;

FIG. 13 is a flowchart showing a print job status setting routine;

FIG. 14 is a flowchart showing a print job distribution routine;

FIG. 15 is a flowchart showing a job execution status output routine;

FIG. 16 is a flowchart showing a job re-execution routine;

FIG. 17 shows one example of job execution status display window 170;

FIG. 18 shows one example of selective input window 180; and

FIG. 19 shows the job execution status display window 170.

### DESCRIPTION OF THE PREFERRED EMBODIMENTS

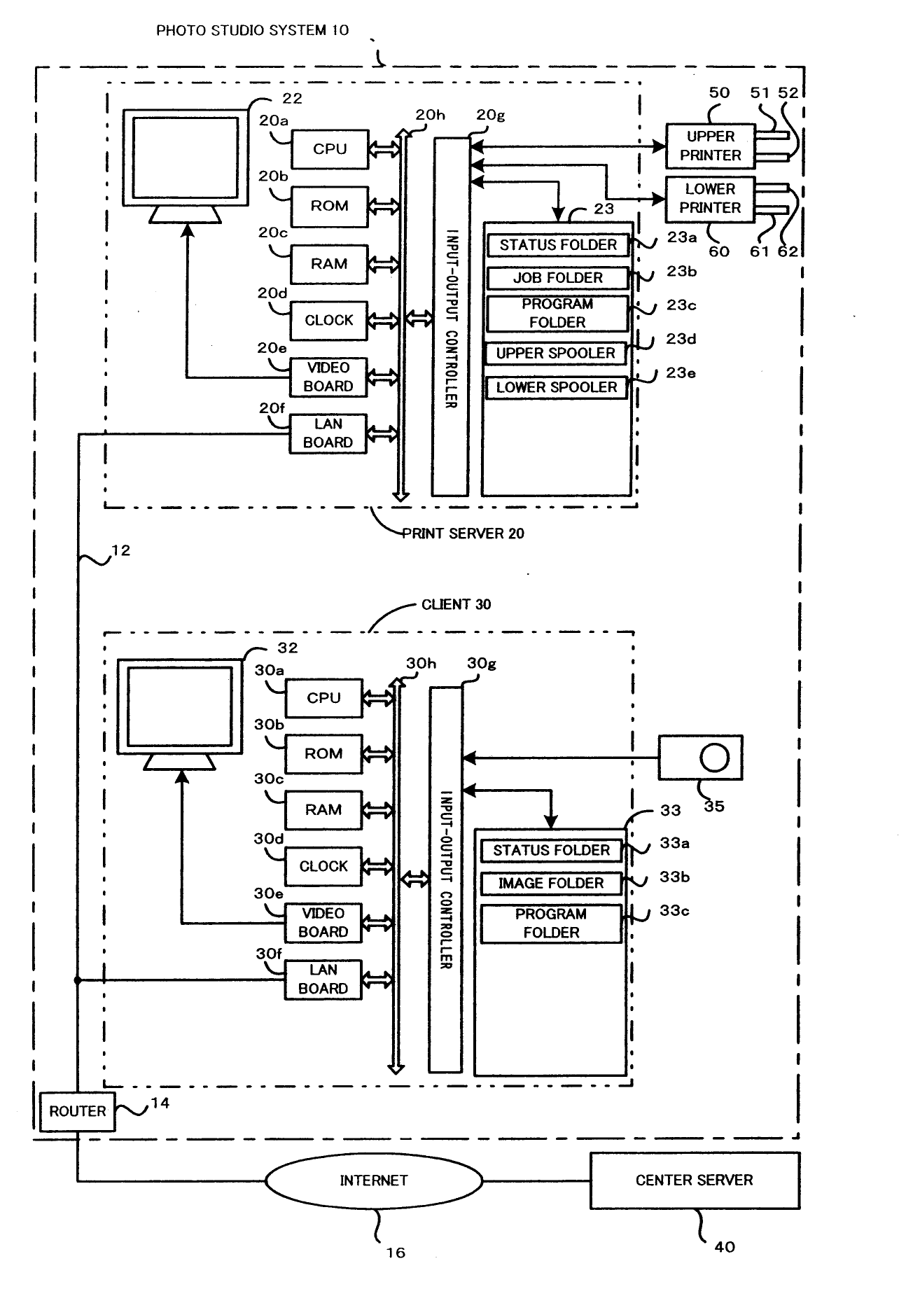

Preferred embodiments of the present invention are discussed below. FIG. 1 schematically illustrates the construction of a photo studio system 10 in one embodiment. The photo studio system 10 of this embodiment has a print server 20 and a client computer (hereafter simply referred to as client) 30, which are connected with each other in a communicable manner via a LAN cable 12. The photo studio system 10 is connected with a center server 40 in a communicable manner via the Internet 16.

The print server 20 includes a CPU 20a that executes a variety of operations, a ROM 20b that stores a group of programs, for example, used for settings of the hardware, a RAM 20c that temporarily stores data in the course of the respective operations executed by the CPU 20a, a clock generator 20d that generates an operation clock, a video board 20e that has a display connector to connect with a display 22, a LAN board 20f that is connected with the LAN cable 12 to establish a LAN, and an input-output controller 20g that controls connection with various devices, where the respective elements are mutually connected via a bus 20h. The input-output controller 20g is linked with a hard disk 23 and is connected with two printers 50 and 60 via USB terminals. The LAN cable 12 linked with the LAN board 20f is also connected to the Internet 16 via the client 30 and a router 14.

The hard disk 23 has a status folder 23a that stores status data of the printers 50 and 60, a job folder 23b that stores print jobs output from the client 30, a program folder 23c that stores a diversity of programs, an upper spooler 23d that stores a current print job in execution of printing and a next print job to be printed next with regard to the upper printer 50 as spools, and a lower spooler 23e that stores a current print job in execution of printing and a next print job to be printed next with regard to the lower printer 60 as spools.

The status folder 23a stores information on paper materials settable in the printers 50 and 60 (settable paper materials), paper materials currently set in the printers 50 and 60 (setting paper materials), and execution statuses of the printers 50 and 60, such as a status in execution of printing, a status of stand-by for printing, or a status of paper jam, as well as ICC profiles representing reproductive color characteristic data of the printers 50 and 60. The ICC profiles are color profiles described in an international color profile format established by ICC (International Color Consortium) among color profile format standards. The job folder 23b stores a variety of data included in the print jobs, such as job scripts each including selection of a printer and a paper material, layout scripts including details required for specifying a print layout, image data set in photograph frames in the layout, and ICC profiles attached to the image data. The program folder 23c includes a printer driver to control the upper printer 50, a printer driver to control the lower printer 60, a color converter to create a color correction table based on the ICC profile of the selected printer and the ICC profile attached to the image data and to execute color correction of the image data, a print control execution program to control execution of each print job, and a Web browser to gain access to various information.

The settable paper materials are specified in advance in a basic configuration as the paper materials settable in the printers 50 and 60. In this embodiment, four paper materials as combinations of two paper sizes (A4 size and long A3 size) with two paper qualities (paper types: matte paper and luster paper) are specified as the settable paper materials.

The printers 50 and 60 are an identical model of ink jet printers using pigment inks, and are capable of outputting prints of the high quality and the extremely high light stability. The printers 50 and 60 and the print server 20 are placed in one casing, where the printer 50 is located on an upper level and the printer 60 is located on a lower level. In the description hereafter, the printer 50 and the printer 60 may thus be referred to as the upper printer and the lower printer, respectively. Sheets of paper materials are fed from two paper cassettes 51 and 52 to the printer 50, while being fed from two paper cassettes 61 and 62 to the printer 60.

The client 30 includes a CPU 30a that executes a variety of operations, a ROM 30 b that stores a group of programs, for example, used for settings of the hardware, a RAM 30 c that temporarily stores data in the course of the respective operations executed by the CPU 30 a, a clock generator 30 d that generates an operation clock, a video board 30 e that has a display connector to connect with a display 32, a LAN board 30 f that is connected with the LAN cable 12 to establish a LAN, and an input-output controller 30 g that controls connection with various devices, where the respective elements are mutually connected via a bus 30 h. The input-output controller 30 g is linked with a hard disk 33 and is connected with a digital still camera 35 via a USB terminal according to the requirements. The LAN cable 12 linked with the LAN board 30 f is connected with the print server 20 and is also connected to the Internet 16 via the router 14.

The hard disk 33 has a status folder 33 a that stores status data transmitted from the print server 20, an image folder 33 b that stores image data photographed by the digital still camera 35 and retouched and other processed image data, and a program folder 33 c that stores a diversity of programs.

The status folder 33 a stores information on paper materials settable in the printers 50 and 60 (settable paper materials), paper materials currently set in the printers 50 and 60 (setting paper materials), and execution statuses of the printers 50 and 60, such as a status in execution of printing, a status of stand-by for printing, or a status of paper jam. These data are updated every time the data stored in the status folder 22 a of the print server 20 are transmitted from the print server 20 at regular intervals or in response to an operator's instructions. The program folder 33 c stores a photo retouching software program to make the photographic image of a digital image subjected to a desired enhancing process, such as trimming, partial modification, or total color adjustment, a layout editing software program to specify a layout of the photographic image of the digital image on a sheet of printing paper and output a print job to the print server 20, and a Web browser to gain access to various information provided by the print server 20 or the center server 40.

The center server 40 functions to intensively manage the operating conditions of multiple photo studio systems 10 placed in a large number of photo studios and is installed at a different position from the photo studios. The center server 40 is connected with the print server 20 and the client computer 30 of each photo studio system 10 in a communicable manner via the Internet 16. The center server 40 functions to collect diverse information from the print server 20 included in each photos studio system 10 and to store and manage the collected information in a database of the center server 40. The center server 40 also functions to estimate the consumptions of expendables like sheets of paper and inks in each photo studio, based on the diverse information on the photo studio and to arrange delivery of required expendables to each photo studio and charge the photo studio for the delivery. The center server 40 further functions to provide the Web browser with the diverse information on each photo studio stored in the database of the center server 40, in response to a log in from the client 30 of the photo studio via the Web browser.

The photo studio system 10 may be used in the following manner. A photographer takes a photograph of a desired photographing object with the digital still camera 35, connects the digital still camera 35 to the client 30, and moves or copies desired image data from an image recording medium built in the digital still camera 35 to the image folder 33 b of the hard disk 33 in the client 30. Various image data are accordingly stored in the image folder 33 b of the client 30. The photographer activates the photo retouching software program on the client 30 and utilizes the functions of the activated photo retouching software program to retouch the image data. According to a concrete procedure, the various image data stored in the image folder 33 b are displayed as thumbnail data on the display 32. In response to selection of desired image data among the various image data, a large photographic image of the desired image data is shown on the center of the display 32. The image data is subjected to a required enhancing process specified on the display, such as trimming, partial modification, or total color adjustment, and is stored again in the image folder 33 b.

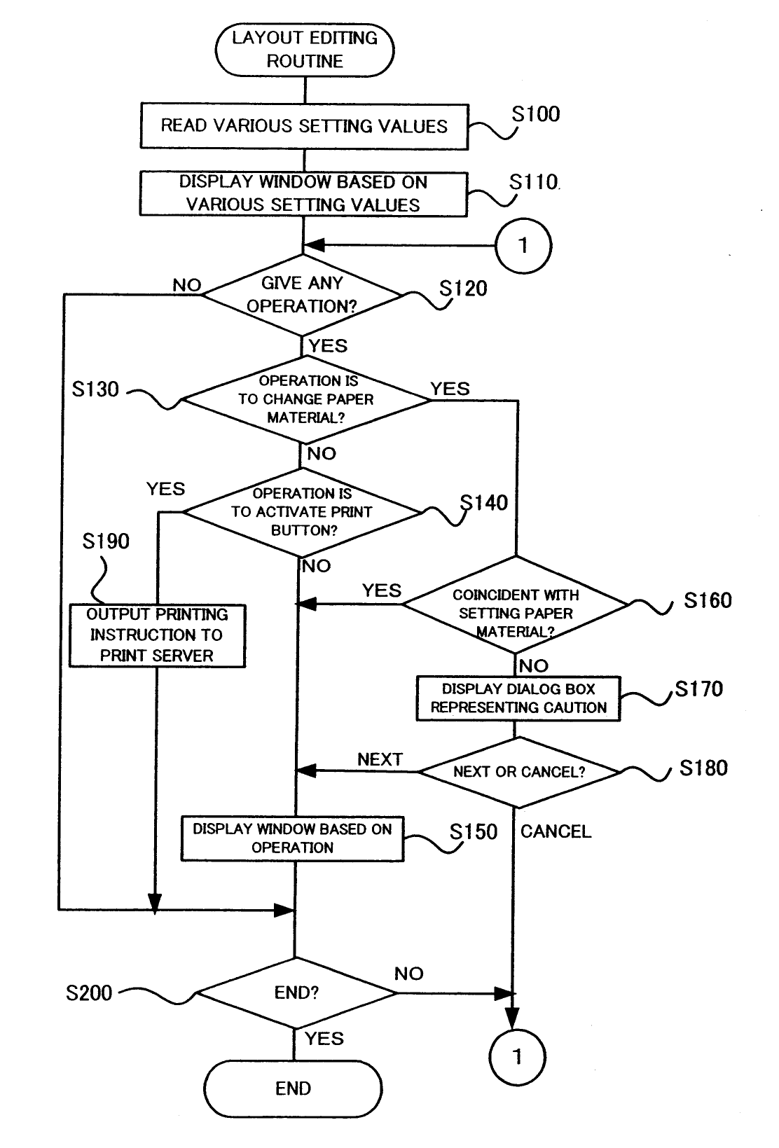

The following describes a layout editing process executed by the client 30. FIG. 2 is a flowchart showing the layout editing process. On activation of a layout editing software program, the CPU 30a of the client 30 first reads various setting values (step S100) and causes a layout editing window 80 to be shown on the display 32, based on the various setting values (step S110).

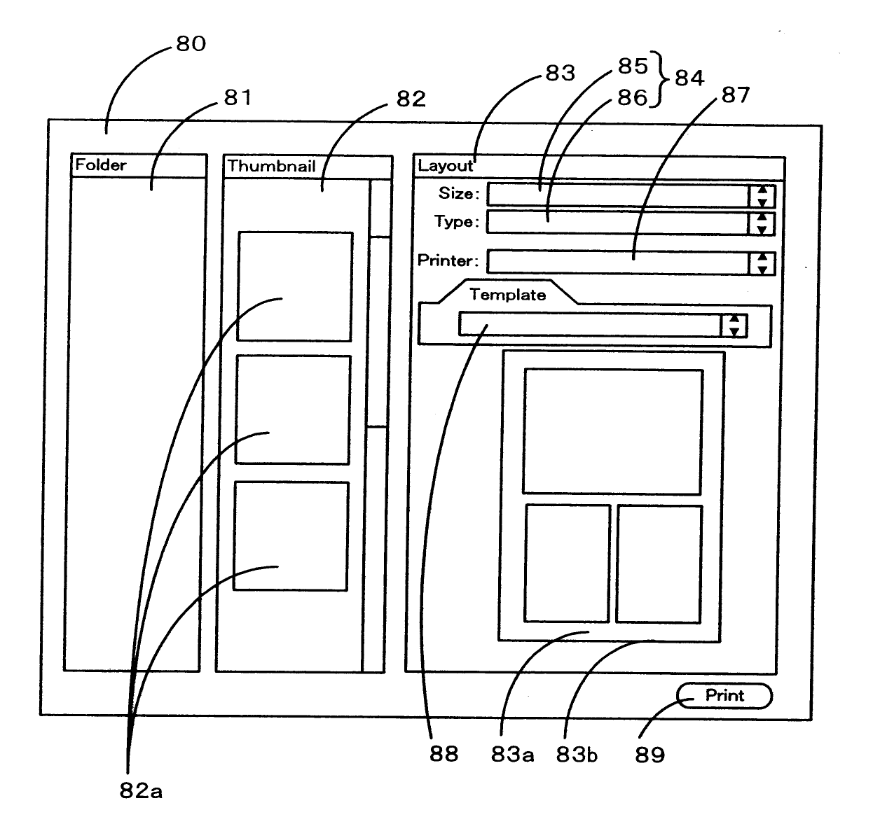

As shown in FIG. 3, the layout editing window 80 includes a folder box 81 to display folders included in the image folder 33 b, a thumb nail box 82 to display the photographic images of image data stored in a folder selected in the folder box 81 as thumb nails 82a, and a layout box 83 including a layout image 83a to display at least one thumb nails 82a selected in the thumb nail box 82 and laid in the respective photograph frames of a predetermined layout 83b. The layout box 83 includes a paper material selection box 84 to select a desired paper material, a printer selection box 87 to select a desired printer, a template selection box 88 to select a desired layout among a group of layout templates, and a print button 89 to give an instruction of printing the layout image 83a. The paper material selection box 84 includes a paper size selection box 85 to select a desired paper size in a pop-up menu and a paper type selection box 86 to select a desired paper type in a pop-up menu. In the structure of this embodiment, the pop-up menu of the paper size includes A4 and A3 long as available paper sizes and the pop-up menu of the paper type includes matte and luster as available paper types, based on the settable paper materials stored in the status folder 33 a of the hard disk 33. The pop-up menu shown in the printer selection box 87 includes the upper printer 50, the lower printer 60, and an auto mode. In the auto mode, the print server 20 automatically selects the printer to be used for printing, according to the vacancy-occupancy statuses of the printers 50 and 60. In the structure of this embodiment, which folder is to be selected in the folder box 81, which paper size and which paper type are to be selected in the paper material selection box 84, and which layout is to be selected are determined in advance as setting values. The procedure reads these setting values at step S100 and displays the window based on these setting values.

Subsequent to step S110, the CPU 30a determines whether or not the client 30 gives any operation on the layout editing window 80 (step S120). The operation may be, for example, a change of the folder selected in the folder box 81, a scroll in the thumb nail box 82, a change of the selection in any of the paper material selection box 84, the printer selection box 87, and the template selection box 88 of the layout box 83, an attachment of a thumb nail 82a to each photograph frame of the layout 83b, or activation of the print button 89. When there is no operation at step S120, the CPU 30a goes to step S200 discussed later. When there is any operation at step S120, on the other hand, the CPU 30a determines whether or not the current operation is to change the paper material selected in the paper material selection box 84 (step S130). When the operation is not to change the paper material, the CPU 30a determines whether or not the current operation is to activate the print button 89 (step S140). When the operation is not to activate the print button 89, the CPU 30a changes the display in the layout editing window 80 on the display 32, based on the current operation (step S150), and then determines whether or not an end button (not shown) of the layout editing software program is activated (step S200). The program exits from this layout editing software program, in response to activation of the end button. Otherwise the program goes back to step S120. When it is determined at step S140 that the current operation is to activate the print button 89, the CPU 30a generates a print job of printing the layout image 83a under the specified conditions and outputs the generated print job to the print server 20 (step S190). The CPU 30a then goes to step S200.

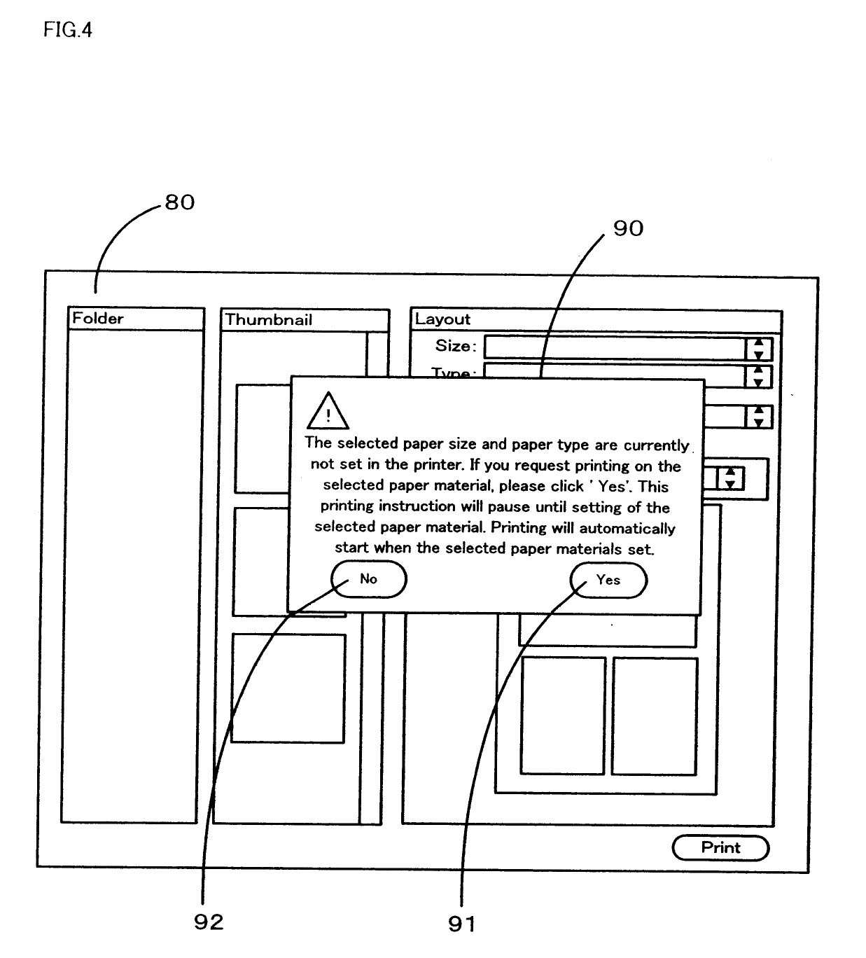

When it is determined at step S130 that the current operation is to change the paper material, the CPU 30a determines whether or not the changed paper material is coincident with any of the setting paper materials (step S160). When the printer 50 is selected in the printer selection box 87, the setting paper materials are paper materials set in the paper cassettes 51 and 52 of the printer 50. When the printer 60 is selected, the setting paper materials are paper materials set in the paper cassettes 61 and 62 of the printer 60. When the auto mode is selected, the setting paper materials are paper materials set in the paper cassettes 51, 52, 61, and 62 of the printers 50 and 60. The information on the setting paper materials is stored in the status folder 33 a of the hard disk 33. The information on the setting paper materials may be acquired from the print server 20 and updated at regular intervals or in response to an operator's instructions. Otherwise the information on the setting paper materials may be acquired from the print server 20 and updated immediately before step S160. When the changed paper material is coincident with any of the setting paper materials, the CPU 30a proceeds to step S150 to change the size and the other factors of the layout 83b and display the changed layout 83b according to the changed paper material. When the changed paper material is not coincident with any of the setting paper materials, on the other hand, the CPU 30a opens a dialog box 90 representing a caution as shown in FIG. 4 on the display 32 (step S170). This caution shows that the print job generated this time is a currently non-processible print job but will be automatically processed after replacement with the changed paper material. A concrete example of such caution is shown in FIG. 4. The dialog box 90 includes a Next button (Yes) 91 to give approval for the caution and continue the processing and a Cancel button (No) 92 to cancel the processing. The client 30 determines whether the Next button or the Cancel button 92 is selected (step S180). In response to selection of the Next button 91, the CPU 30a goes to step S150 to change the size and the other factors of the layout 83b and display the changed layout 83b according to the changed paper material. In response to selection of the Cancel button 92, on the other hand, the CPU 30a goes back to step S120.

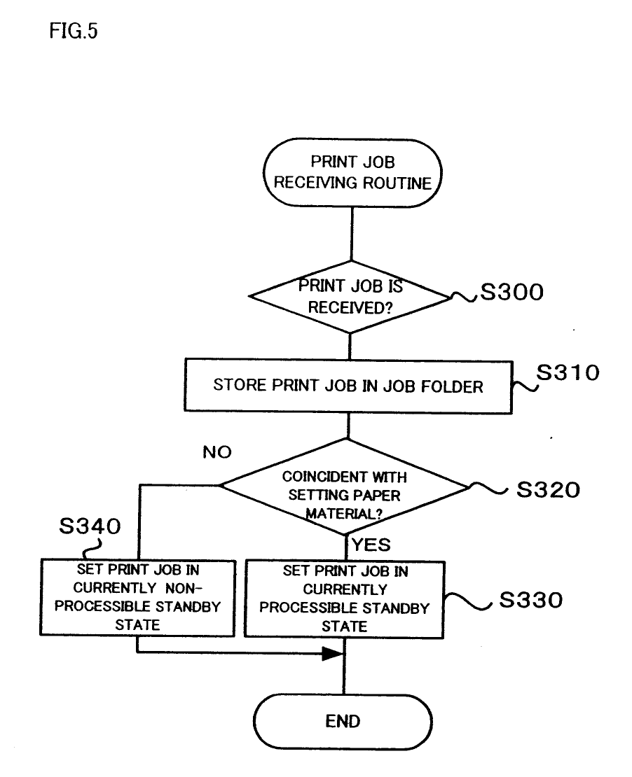

The following describes a print job receiving process executed by the print server 20. FIG. 5 is a flowchart showing the print job receiving process. The CPU 20a of the print server 20 reads a print job receiving program from the program folder 23c of the hard disk 33 and executes the print job receiving program at preset timings. When the program enters the print job receiving routine, the CPU 20a first determined whether or not a print job is received from the client 30 (step S300). When no print job is received, the program immediately exits from this processing routine. When a print job is received, the CPU 20a stores the respective data included in the print job in the job folder 23b (step S310). The CPU 20a subsequently determines whether or not the paper material selected in the print job is coincident with any of the setting paper materials (step S320). When the selected paper material is coincident with any of the setting paper materials, the CPU 20a sets the print job in a currently processible standby state (step S330). When the selected paper material is not coincident with any of the setting paper materials, on the other hand, the CPU 20a sets the print job in a currently non-processible standby state (step S340). The program then exits from this processing routine.

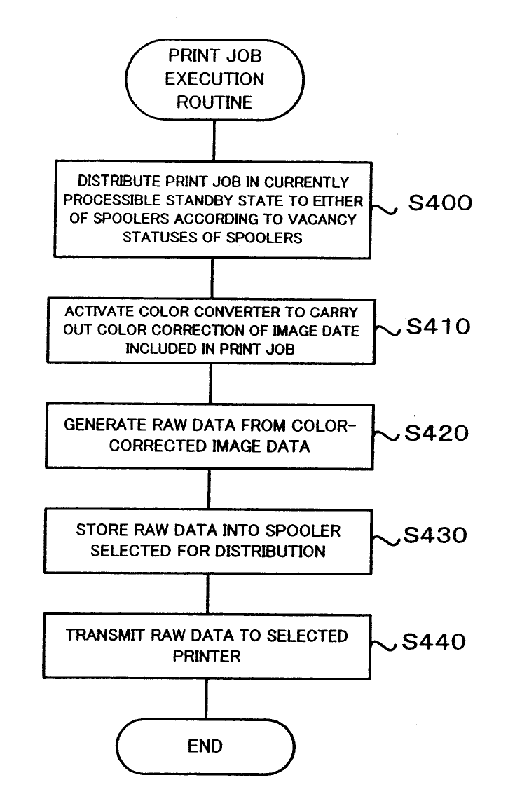

A print job execution process executed by the print server 20 is described below. FIG. 6 is a flowchart showing the print job execution process. The CPU 20a of the print server 20 reads a print job execution program from the program folder 23c of the hard disk 33 and executes the print job execution program at preset timings, independently of the print job receiving process described above. When the program enters this print job execution routine, the CPU 20a reads print jobs in the currently processible standby state stored in the job folder 23b, based on the vacancy-occupancy statuses of the upper spooler 23d and the lower spooler 23e, and distributes each of the print jobs to either the upper spooler 23d or the lower spooler 23e (step S400). In principle, the print jobs are distributed sequentially in the input order. When a print job includes specification of the printer, the print job is distributed to the spooler corresponding to the specified printer. When a print job does not specify the printer but is set in the auto mode, the print job is distributed to the spooler corresponding to the printer with the setting paper material that is coincident with the paper material selected in the print job. When the selected paper material is set in both of the printers, the print job is distributed to the spooler corresponding to the printer having a vacant spool. The distribution of print jobs will be discussed later in a second embodiment. Each of the upper spooler 23d and the lower spooler 23e may have two spools. One spool is for the print job that is currently being printed, and the other spool is for the print job that will be printed next time. After distribution to the spooler at step S400, the CPU 20a activates a color converter to carry out color correction of the image data included in each print job (step S410). The color converter creates a color correction table based on the ICC profile included in each print job and the ICC profile of the printer corresponding to the spooler, to which the print job is distributed, and carries out color correction of the image data included in the print job according to the color correction table. The CPU 20a then activates the printer driver of the selected printer to make the color-corrected image data subjected to conversion into CMYK color data and a halftoning process, so as to generate RAW data processible by the selected printer (step S420). The CPU 20a subsequently stores the generated RAW data as a spool in the spooler corresponding to the selected printer (step S430), and transmits the RAW data to the selected printer (step S440). The program then exits from this print job execution routine. The print job causes the printer 50 or 60 to print preset image data in a predetermined layout on a predetermined paper material.

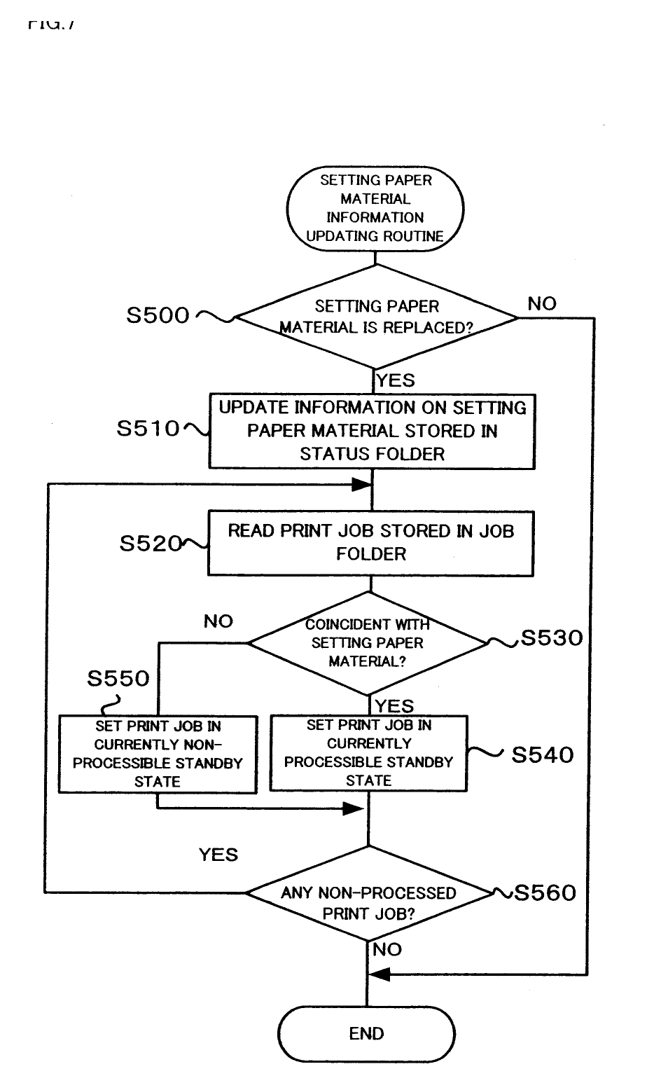

The following describes a setting paper material information updating process executed by the print server 20. FIG. 7 is a flowchart showing the setting paper material information updating process. The CPU 20a of the print server 20 reads a setting paper material information updating program from the hard disk 33 and executes the setting paper material information updating program at preset timings, independently of the print job receiving process and the print job execution process described above. When the program enters this updating routine, the CPU 20a first determines whether or not any of the setting paper materials currently set in the printers 50 and 60 is replaced (step S500). In the case of no replacement, the program immediately exits from this processing routine. In the case of replacement, on the other hand, the CPU 20a updates the information on the setting paper material stored in the status folder 23a to the information on the replaced setting paper material (step S510). The CPU 20a subsequently determines whether or not the selected paper material in each of the print jobs stored in the job folder 23b is coincident with any of the setting paper materials (step S520). When the selected paper material is coincident with any of the setting paper materials, the CPU 20a sets the print job in the currently processible standby state (step S530). When the selected paper material is not coincident with any of the setting paper materials, on the other hand, the CPU 20a sets the print job in the currently non-processible standby state (step S540). The program then exits from this processing routine. When any of the setting paper materials set in the printers 50 and 60 is replaced and the paper material selected in the print job in the currently non-processible standby state is coincident with the replaced setting paper material, the print job is updated to the currently processible standby state and is processed by the print job execution process discussed above.

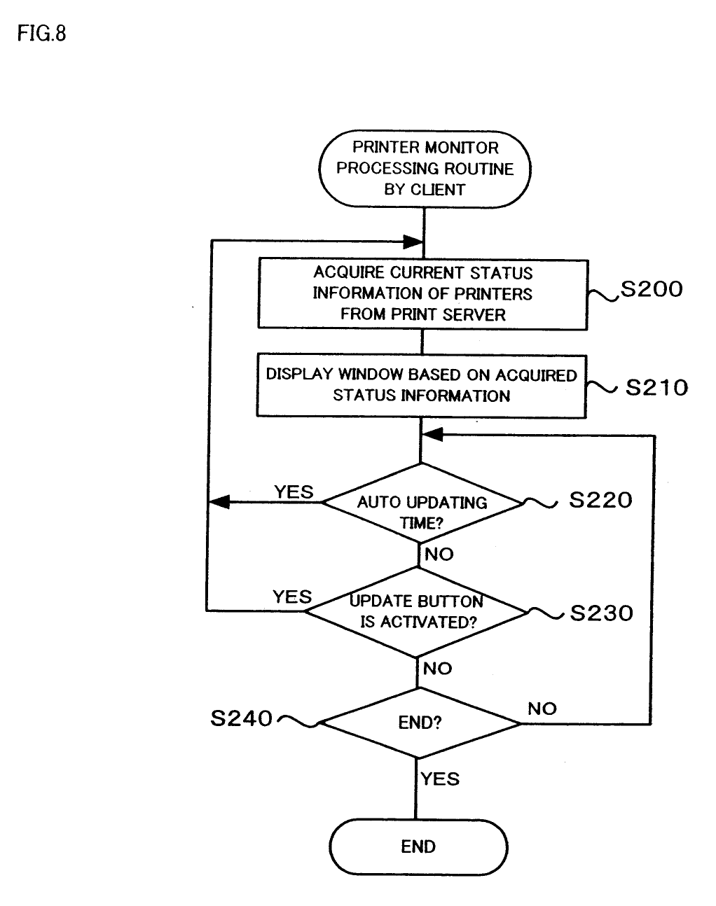

A printer monitor processing routine executed by the client 30 is discussed below. FIG. 8 is a flowchart showing the printer monitor processing routine. When a Web browser is activated and a URL including an IP address of the print server 20 is input, the CPU 30a of the client 30 acquires the current status data of the printers 50 and 60 from the print server 20 via the LAN cable 12 and stores the status data into the status folder 33 a of the hard disk 33 (step S200). The CPU 30a subsequently causes a printer monitor window 70 to be shown on the display 32, based on the acquired status data (step S210).

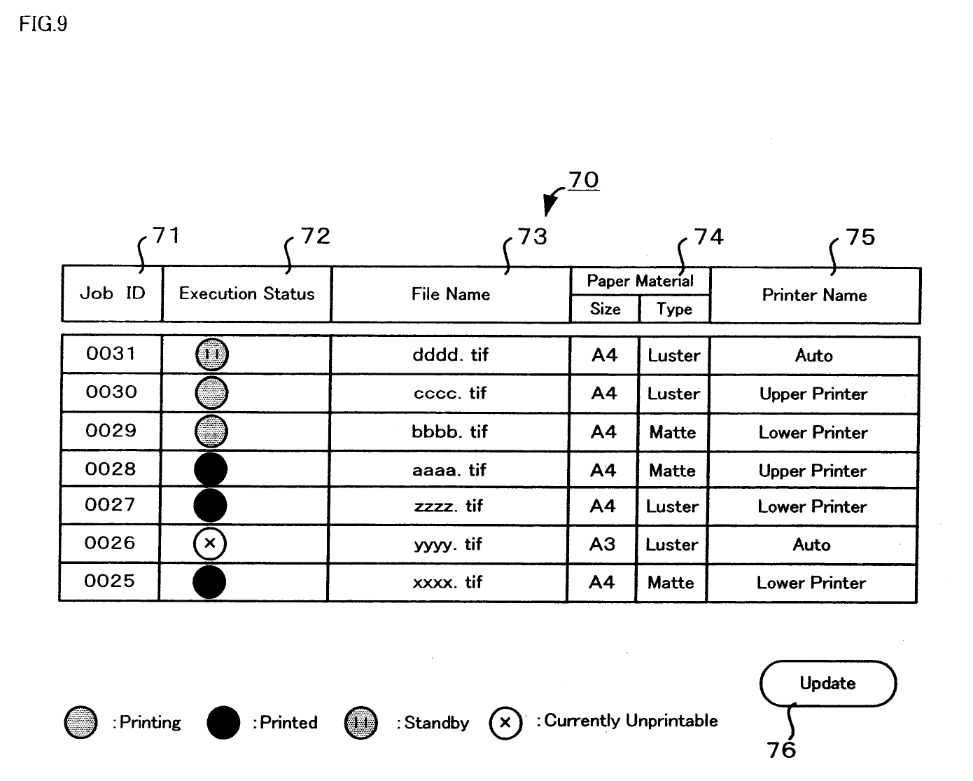

FIG. 9 shows an example of the printer monitor window 70. The printer monitor window 70 includes a job ID display box 71 to show a job ID allocated to each of the print jobs, an execution status display box 72 to show the execution status of each print job, printing, printed, standby, or currently unprintable, a file name display box 73 to show the file name of each print job, a paper material display box 74 to show the selected paper material for each print job, and a printer name display box 75 to show the name of the printer that has executed, is executing, or is scheduled to execute each print job. In this example, the A4 matte paper and the A4 luster paper are set respectively in the paper cassettes 51 and 52 of the upper printer 50. The A4 matter paper and the A4 luster paper are also set respectively in the paper cassettes 61 and 62 of the lower printer 60. In the printer monitor window of FIG. 9, a job ID ‘0029’ is currently being printed on the A4 matte paper by the lower printer 60, while a job ID ‘0030’ is currently being printed on the A4 luster paper by the upper printer 50. A job ID ‘0031’ is in the standby state and has the ‘auto’ mode in the printer name display box 75. The job ID ‘0031’ is thus automatically distributed to the printer having a vacancy first between the printers 50 and 60 and is to be printed on the A4 luster paper. A job ID ‘0026’ represents a printing instruction on the A3 luster paper and is thus currently unprintable. After the A3 luster paper is set in any of the paper cassettes of the printers 50 and 60, the job ID ‘0026’ is to be automatically printed on the A3 luster paper. The other job IDs have already been printed.

The CPU 30a then determines whether or not a preset auto updating time has come (step S220), and determines whether or not an Update button 76 on the printer monitor window 70 is activated (step S230). When the auto updating time has come at step S220 or when the Update button 76 is activated at step S230, the CPU 30a goes back to step S200 to acquire the current status data of the printers 50 and 60 from the print server 20 again. When the auto updating has not yet come at step S220 and when the Update button 76 is not activated at step S230, the CPU 30a determines whether or not an End button of the printer monitor processing routine is activated (step S240). In response to no activation of the End button, the program returns to step S220. In response to activation of the End button, on the other hand, the program exits from this printer monitor processing routine.

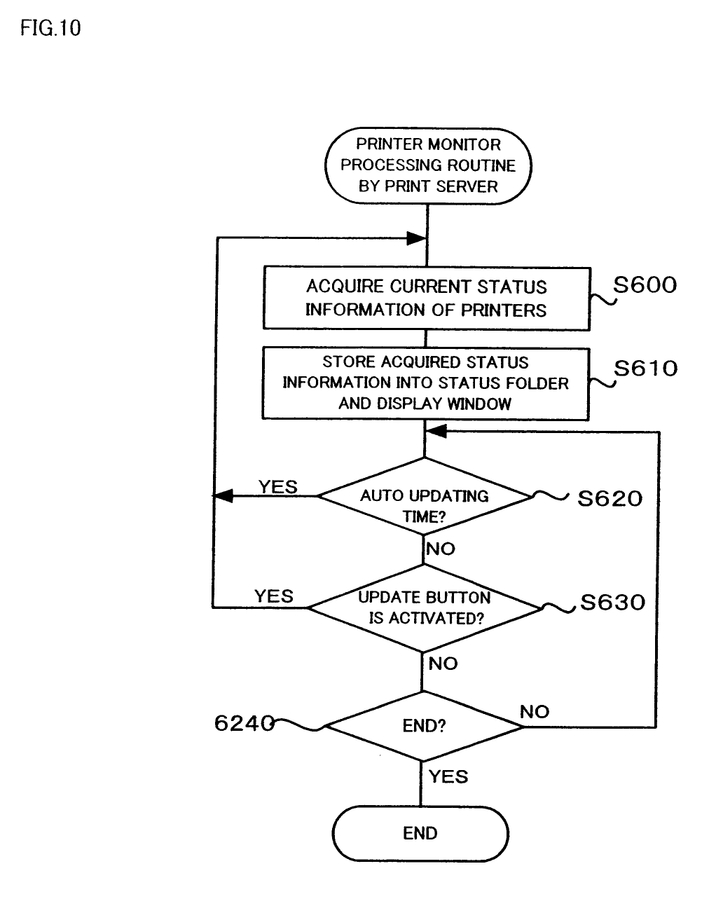

The print server 20 may execute a printer monitor processing routine, like the processing routine executed by the client 30. FIG. 10 is a flowchart showing a printer monitor processing routine executed by the print server 20. When the program enters this printer monitor processing routine, the CPU 20a of the print server 20 first reads the current status data of the printers 50 and 60 from the printers 50 and 60 (step S600), and stores the current status data into the status folder 23a of the hard disk 23 and causes a printer monitor window to be shown on the display 22 (step S610). This printer monitor window displays the status data like the printer monitor window 70 of the client 30 and is thus not specifically described here. The CPU 20a then determines whether or not a preset auto updating time has come (step S620), and determines whether or not an Update button 76 on the printer monitor window 70 is activated (step S630). When the auto updating time has come at step S220 or when the Update button 76 is activated at step S630, the CPU 20a goes back to step S600 to acquire the current status data of the printers 50 and 60 again. When the auto updating has not yet come at step S620 and when the Update button 76 is not activated at step S630, the CPU 20a determines whether or not an End button of the printer monitor processing routine is activated (step S640). In response to no activation of the End button, the program returns to step S220. In response to activation of the End button, on the other hand, the program exits from this printer monitor processing routine.

The client 30 of this embodiment discussed above generates a print job including the selected paper material identical with any of the settable paper materials and outputs the print job to the print server 20, whether or not the selected paper material is coincident with any of the setting paper materials. Multiple print jobs having different paper materials can thus be sequentially generated and output to the print server 20 without any delay. This arrangement ensures efficient output of the print jobs.

When the selected paper material is not coincident with any of the setting paper materials, the client 30 of this embodiment notifies the operator of a caution. The caution shows that the print job generated this time is a currently non-processible print job but will automatically be processed when the selected paper material is set in either of the printers 50 and 60 of the print server 20. In response to the operator's approval, the client 30 generates and outputs a print job of printing the layout image 83a as the object print data on the selected paper material. This arrangement effectively prevents any currently non-processible print job from being output to the print server 20 without approval of the operator. This arrangement also readily notifies the operator of the situation that the currently non-processible print job will automatically be processed when any of the setting paper materials set in the printers 50 and 60 is replaced with the selected paper material in the print job. The operator can readily and accurately grasp the contents of the notification by reading the letter message of the caution.

The client 30 of this embodiment acquires the status data (including the execution status) of the printers 50 and 60 from the print server 20 and displays the printer monitor window 70 including the acquired status data. In the display, any currently non-processible print job has the non-processible execution status. The operator can thus readily check which print job is in the currently non-processible state, based on the execution statuses displayed on the printer monitor window 70. The display shows the selected paper material of the print job in the currently non-processible state. The operator can thus readily specify the paper material to be set in either of the printers 50 and 60, in order to process the print job in the currently non-processible state. The status data including the execution status are acquired at regular intervals or in response to the operator's instructions. The contents of the display on the printer monitor window 70 are thus not significantly behind the actual situation.

The client 30 of this embodiment acquires the information on the settable paper materials and the setting paper materials from the print server 20 and stores the acquired information into the status folder 33 a of the hard disk 33. The operator is thus not required to input the settable paper materials and the setting paper materials on the client 30. The paper materials set in the printers 50 and 60 may be replaced. The arrangement of acquiring the information on the setting paper materials at regular intervals or in response to the operator's instructions enables the information on the setting paper materials stored in the client 30 to be updated to the paper materials actually set in the printers at the early stage.

The paper material is generally defined by the paper size and the paper type. The client 30 of this embodiment thus selects the paper size and the paper type to specify the paper material in the paper material selection box 84. This ensures output of suitable print jobs. The layout edition is generally carried out after specification of the paper material including the paper size. Selection of the paper material on the layout editing window 80 desirably enhances the working ability.

The print server 20 of this embodiment receives a print job of printing image data on the selected paper material from the client 30 via the LAN cable 12. When the selected paper material included in the input print job is not coincident with any of the setting paper materials stored in the status folder 23a, the print server 20 holds the input print job as a currently non-processible print job. When any of the setting paper materials is replaced and the selected paper material included in the currently non-processible print job is coincident with the replaced setting paper material, the print server 20 holds the print job as a currently processible print job. The currently processible print job is printed by either of the printers 50 and 60. The print server 20 holds even the currently non-processible print job and automatically processes the print job when its status is changed to processible. This arrangement enables multiple print jobs having different paper materials to be accumulated and processed efficiently.

The print server 20 of the embodiment changes the status of a currently non-processible print job to the currently processible status, when any of the setting paper materials in the printers 50 and 60 is replaced to update the information on the setting paper materials stored in the status folder 23a and the selected paper material included in the print job is coincident with the replaced setting paper material. The procedure of this embodiment updates the information on the setting paper materials stored in the status folder 23a every time any of the setting paper materials in the printers 50 and 60 is replaced, according to the setting paper material information updating process (FIG. 7). This arrangement changes the status of the currently non-processible print job to the currently processible status without delay and thus ensures efficient processing of the print jobs.

The print server 20 of this embodiment executes the printer monitor processing routine (FIG. 10) and causes the status data including the execution statuses of the printers 50 and 60 to be shown in the display 22. The display shows the execution status of the currently non-processible print job as the currently non-processible status. The operator can thus readily check which print job is currently non-processible based on the execution statuses. The display also includes the selected paper material in the currently non-processible print job. The operator can thus readily specify the paper material to be set in either of the printers 50 and 60, in order to change the status of the currently non-processible print job to the currently processible state. The status data are acquired at regular intervals or in response to the operator's instructions. The contents of the display on the printer monitor window are thus not significantly behind the actual situation.

The procedure of the above embodiment displays the letter message in the dialog box 90 to give a caution to the operator. Audio data representing the letter message may be output in addition to or in place of the letter message. A specific icon representing this letter message may otherwise be displayed.

When the basic configuration is changed in the print server 20, the information on the changed settable paper materials may be transmitted from the print server 20 and automatically updated. When any of the setting paper materials in the printers 50 and 60 is replaced, the information on the replaced setting paper material is transmitted from the printer server 20 and automatically updated.

In the above embodiment, the client 30 acquires the information on the settable paper materials and the setting paper materials from the print server 20. The operator may input the settable paper materials and the setting paper materials through operations of a keyboard on the client 30.

Each of the print server 20 and the client 30 may be constructed by one computer or by multiple computers, and may include a variety of peripheral equipment. In the photo studio system 10, multiple clients 30 may be connected with one print server 20 via the LAN cable 12, or multiple print servers 20 may be connected with one client 30 via the LAN cable 12.

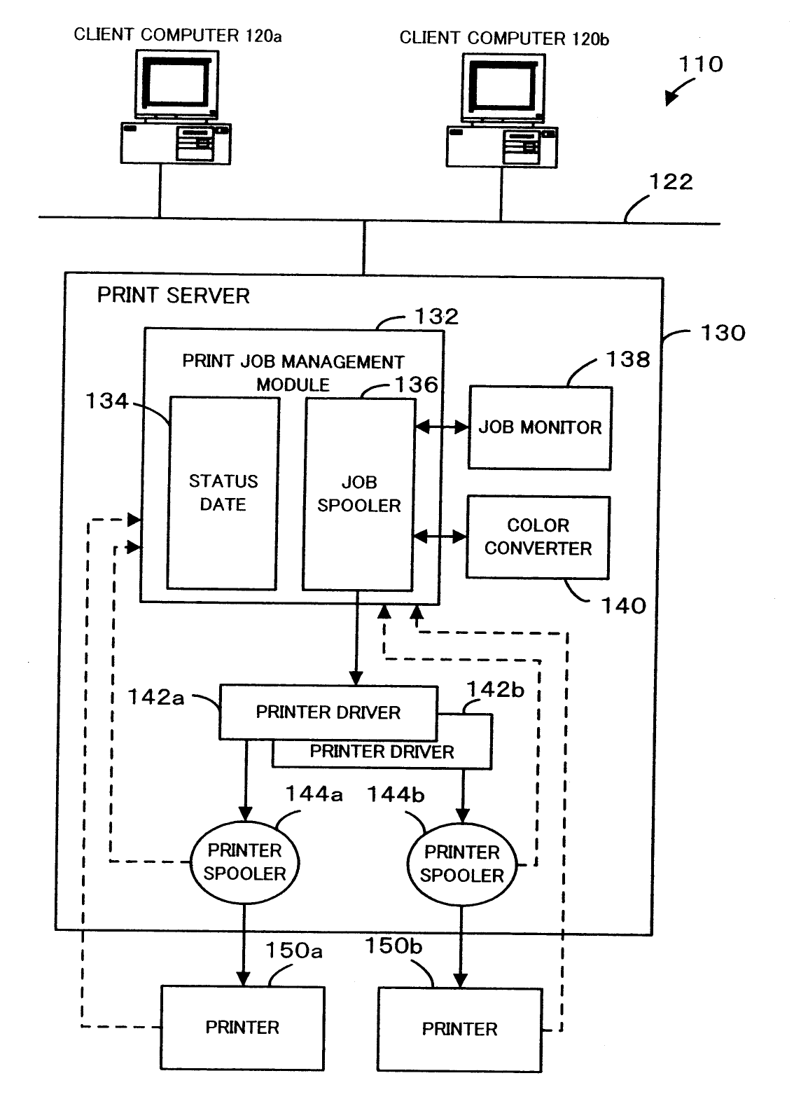

Another printing system is discussed below as a second embodiment of the present invention. FIG. 11 is a block diagram showing the functional blocks of a print server 130 in a printing system 110 of the second embodiment. As illustrated, the printing system 110 of the second embodiment includes client computers 120a and 120b and a print server 130. The client computers 120a and 120b have the identical hardware structure with that of the client 30 of the first embodiment and output print jobs to the print server 130 according to the similar procedure. The detailed description of the hardware construction of and the series of processing executed by the client computers 120a and 120b is thus omitted. The print server 130 has the identical hardware structure with that of the print server 20 of the first embodiment. For convenience of explanation, however, the operations of the print server 130 in the second embodiment are discussed with reference to the functional blocks.

As shown in FIG. 11, the print server 130 of the second embodiment manages execution of print jobs transmitted from the client computers 120a and 120b connecting with a LAN 122, and uses two printers 150a and 150b to execute the print jobs. The print server 130 includes a print job management module 132, which has status data 134 that are acquired from the printers 150a and 150b and a job spooler 136 that holds the print jobs sent from the client computers 120a and 120b, and a job monitor 138 that monitors the status of each print job held in the job spooler 136 at preset frequencies. The print server 130 also includes a color converter 140 that carries out color correction of image data to be printed, based on the ICC profile of the print job and the ICC profile of the printer used for printing, printer drivers 142a and 142b that convert the color-corrected image data into CMYK color data and carry out a halftoning process to generate print data printable by the printer, and printer spoolers 144a and 144b that are respectively capable of holding two print data including the print data currently being printed by the printer.

Each of the print jobs sent from the client computers 120a and 120b and held in the job spooler 136 has a data file including image data to be printed, a condition file, in which printing conditions, such as the layout of images, the type and the size of printing paper, the ink type, the number of printing pages, and the specification of the printer used for printing, are described, and the ICC profile. The ICC profile has been discussed previously.

The status data 134 include information on the types and the sizes of printing paper and the ink types settable in the printers 150a and 150b and the types and the size of printing paper and the ink types currently set in the printers 150a and 150b, the status information of the printers 150a and 150b like paper jam, the ICC profiles of the printers 150a and 150b, and the number of print jobs held in the printer spoolers 144a and 144b.

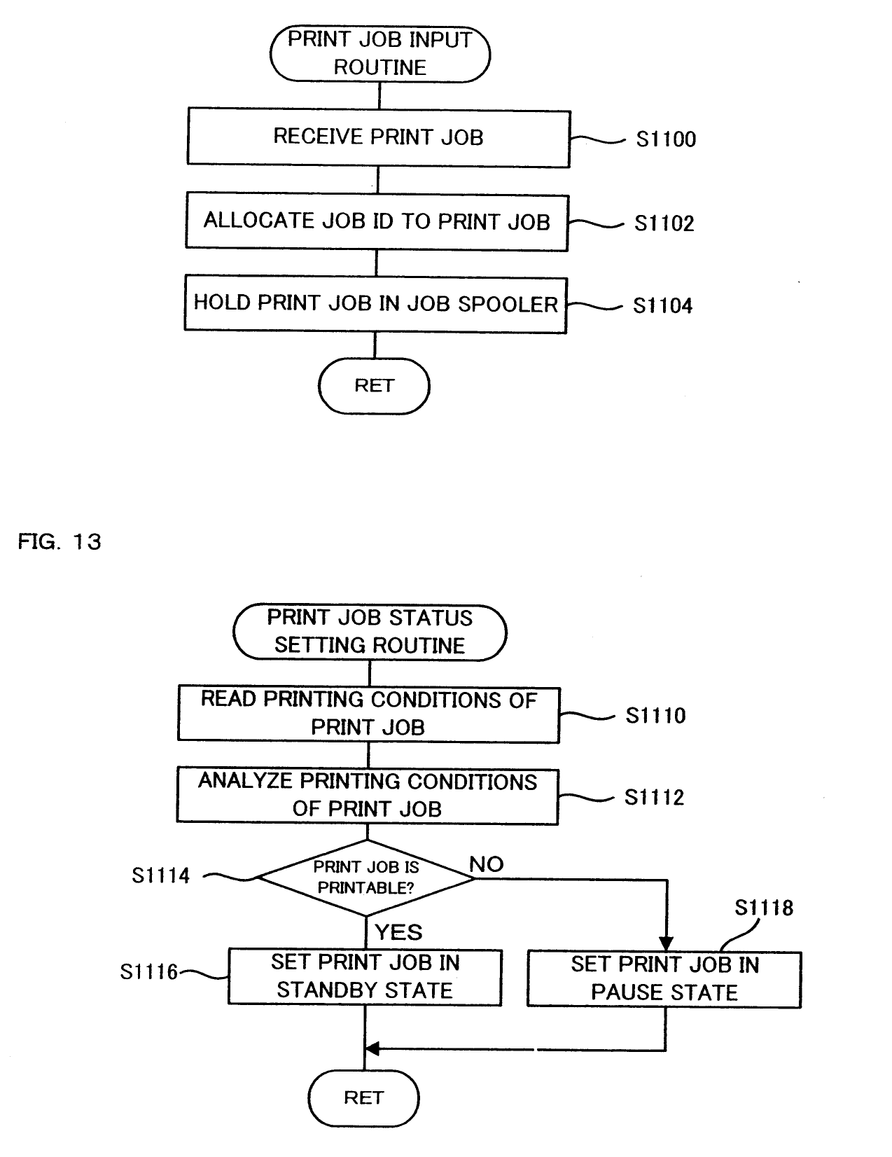

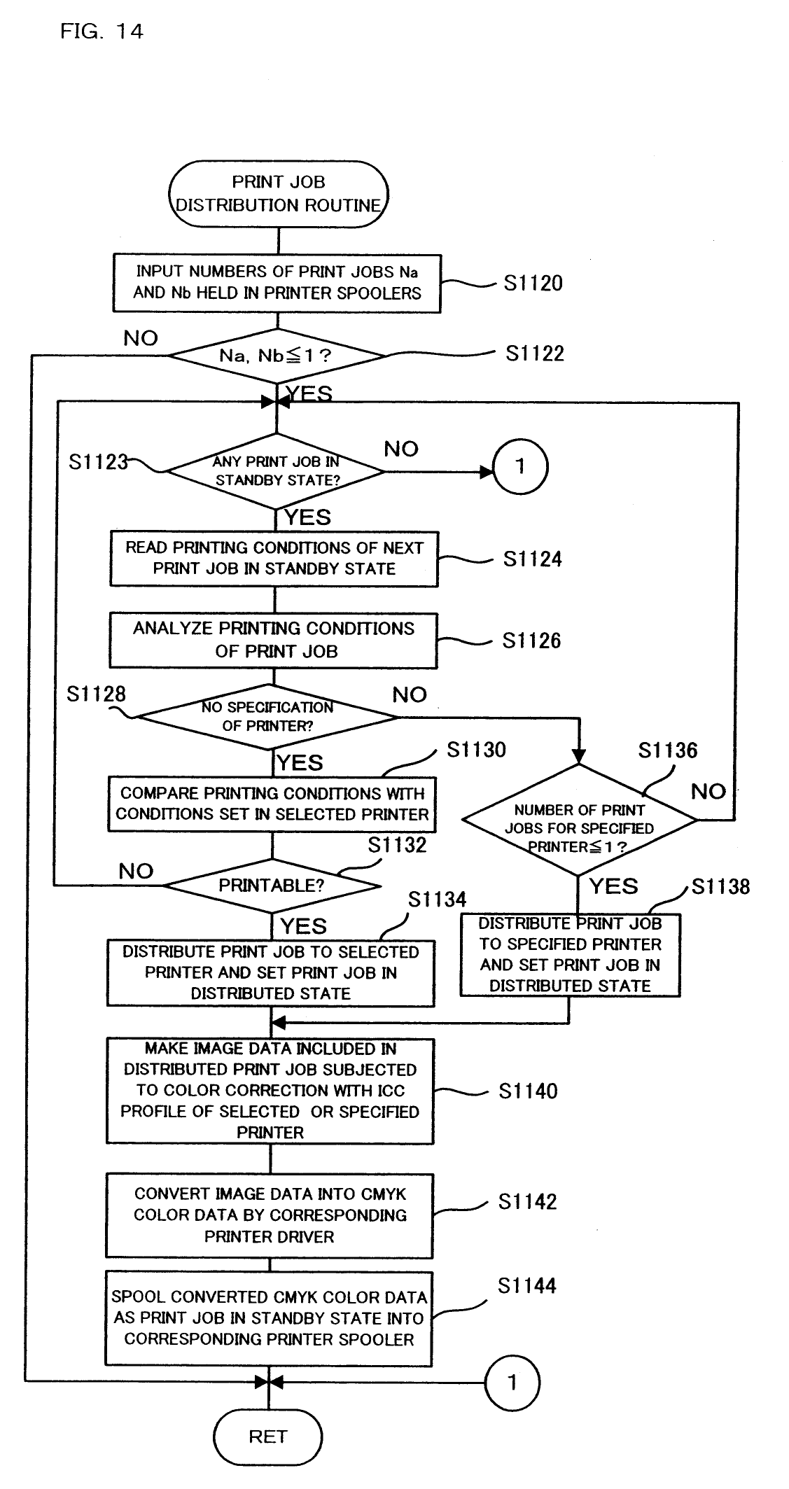

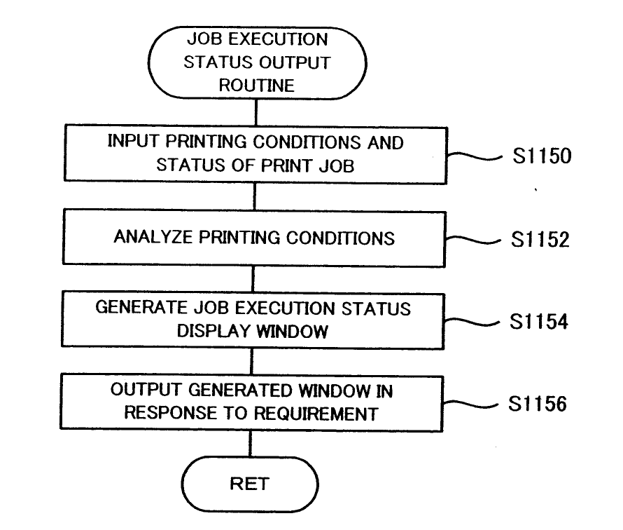

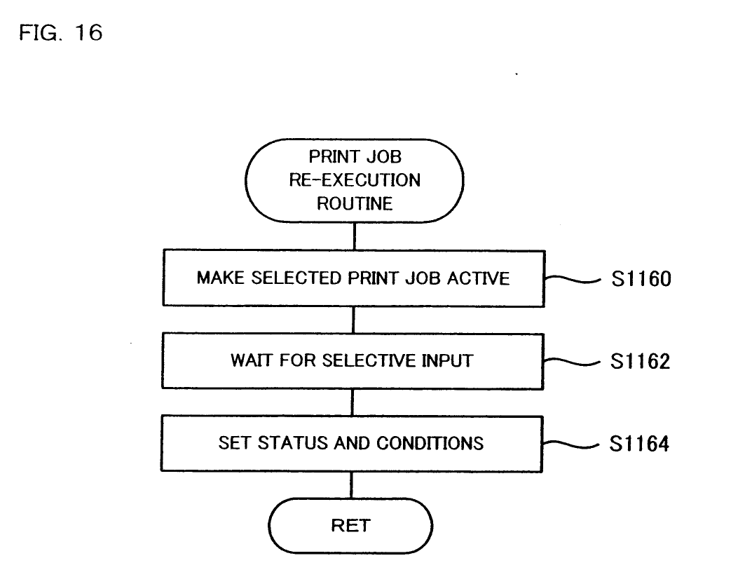

The following describes the operations of the print server 130 of the second embodiment thus constructed. The print server 130 of the second embodiment executes a print job input routine shown in FIG. 12, a print job status setting routine shown in FIG. 13, a print job distribution routine shown in FIG. 14, a job execution status display routine shown in FIG. 15, and a print job re-execution routine shown in FIG. 16.

The print job input routine is executed by the print job management module 132, in response to reception of a signal that represents transmission of a print job from either of the client computers 120a and 120b. As shown in FIG. 12, the print job input routine receives each print job transmitted from either of the client computers 120a and 120b (step S1100), allocates a job ID to the received print job (step S1102), and holds the print job with the job ID in the job spooler 136 (step S1104). The program then exits from this processing routine. The job IDs are allocated to the print jobs in the order of reception and are written in the condition file.

The print job status setting routine is iteratively executed by the print job management module 132 at preset time intervals (for example, at every 10 seconds). As shown in FIG. 13, the print job status setting routine first reads the printing conditions from the condition file of each print job held in the job spooler 136 (step S1110), and analyzes the printing conditions of the print job (step S1112). The routine then determines whether or not the print job is printable by either of the printers 150a and 150b, based on the analyzed printing conditions (step S1114). The printability or unprintability is determined according to the coincidence or difference of the analyzed printing conditions with or from the type and the size of the printing paper and the ink type currently set in either of the printers 150a and 150b. When it is determined that the print job is printable, the print job is set in a standby state (step S1116). When it is determined that the print job is unprintable, on the other hand, the print job is set in a pause state (step S1118). The program then exits from this print job status setting routine. The print job status setting routine is executed at preset frequencies. When any of the type and the size of the printing paper and the ink type currently set in either of the printers 150a and 150b is changed, the printing conditions of a print job in the standby state may become different from the settings, due to such a change. In this case, the status of the print job is changed from the standby state to the pause state. Such a change may also cause the printing conditions of a print job in the pause state to be coincident with the settings. In this case, the status of the print job is changed from the pause state to the standby state. The print job set in the pause state is thus changed to the standby state, when any of the type and the size of the printing paper and the ink type currently set in either of the printers 150a and 150b is changed to become coincident with the printing conditions. The setting of the standby state or the pause state may be written in a predetermined place of the condition file of the print job. Otherwise the print job management module 132 may store the setting in a predetermined area of the built-in RAM.

The print job distribution routine is iteratively executed mainly by the print job management module 132 at preset time intervals (for example, at every 10 seconds). As shown in FIG. 14, this print job distribution routine first reads numbers of print jobs Na and Nb held in the printer spoolers 144a and 144b from the status data 134 (step S1120), and determines whether or not either of the numbers of print jobs Na and Nb is not greater than 1 (step S1122). As described previously, each of the printer spoolers 144a and 144b is capable of holding two print data as converted CMYK color data including print data currently being printed. The process of step S1120 thus determines whether or not either of the printer spoolers 144a and 144b has a vacancy for holding print data. When neither the printer spooler 144a nor the printer spooler 144b has any vacancy for holding print data, it is determined that distribution of any print job is not required. The program thus exits from the print job distribution routine.

When either of the print spoolers 144a and 144b has a vacancy for holding print data, on the other hand, the routine determines whether or not the job spooler 136 has any print job in a standby state (step S1123). When there is no print job in the standby state, it is determined that distribution of any print job is not required. The program thus exits from the print job distribution routine. When there is any print job in the standby state, on the other hand, the routine reads the printing conditions of a next print job in the standby state in the order of storage in the job spooler 136 (step S1124), analyzes the printing conditions (step S1126), and determines whether or not the analyzed printing conditions include specification of the printer used for printing (step S1128). When there is no specification of the printer, the routine compares the analyzed printing conditions with the settings of a selected printer stored in the status data 134, that is, the type and the size of printing paper and the ink type currently set in the printer connected with the printer spooler having the vacancy for holding print data (step S1130), and determines whether or not the print job is printable (step S1132). In the case of printable, the print job is distributed to the selected printer and changes the status of the print job from the standby state to a distributed state (step S1134). In the case of unprintable, on the contrary, it is determined that distribution of the print job is currently not allowed. The routine then goes back to step S1123. The name of the printer to which the print job is distributed is included in the settings of the print job in the distributed state.

When the printing conditions include specification of the printer at step S1128, on the other hand, the routine determines whether or not the number of print jobs held in the printer spooler corresponding to the specified printer is not greater than 1, that is, whether or not the corresponding spooler has a vacancy for holding print data (step S1136). When there is any vacancy, the routine distributes the print job to the specified printer and changes the status of the print job from the standby state to the distributed state (step S1134). When there is no vacancy, on the other hand, it is determined that distribution of the print job is currently not allowed. The routine then goes back to step S1123.

After distribution of the print job to the specified or selected printer, the routine carries out color correction of image data included in the distributed print job with the ICC profile of the specified or selected printer (step S1140). The procedure of color correction creates a color correction table based on the ICC profile of the specified or selected printer and the ICC profile of the print job, and carries out color correction of the image data included in the print job according to the color correction table. The color conversion is carried out by the color converter 140, which receives the ICC profile of the specified or selected printer, the ICC profile of the print job, and the image data from the print job management module 132. The color-corrected image data is sent back from the color converter 140 to the print job management module 132.

The color-corrected image data are then subjected to color conversion into CMYK color data and a halftoning process executed by the printer driver of the specified or selected printer, to which the print job is distributed, and are thereby converted to print data processible by the printer (step S1142). The routine transfers the print data as a print job in the standby state to the printer spooler of the specified or selected printer (step S1144). The program then exits from this print job distribution routine. When execution of the current print job is concluded, the printer spooler 144a or 144b outputs the print data held therein as the print job in the standby state to the printer 150a or 150b to start printing, while changing the status of the print job from the distributed state to a printing state. On conclusion of the print job, the printer spooler 144a or 144b changes the status of the concluded print job from the printing state to a printed state. The setting status of the print job is written in the condition file of the print job held in the job spooler 136, as described previously.

The job execution status output routine is iteratively executed by the job monitor 138 at preset time intervals (for example, at every 5 minutes). As shown in FIG. 15, the job execution status output routine first reads the printing conditions and the setting status from the condition file of each print job held in the job spooler 136 (step S1150), and analyzes the printing conditions (step s1152). The routine then generates a job execution status display window as a Web page, based on the analyzed printing conditions and the setting status (step S1154) and outputs the job execution status display window in response to a requirement sent from the job monitor 138 or the client computer 120a or 120b (step S1156). The program then exits from this job execution status output routine. In this embodiment, the job execution status display window is generated as a Web page and may thus be displayed by the job monitor 138 or by the browser of the client computer 120a or 120b.

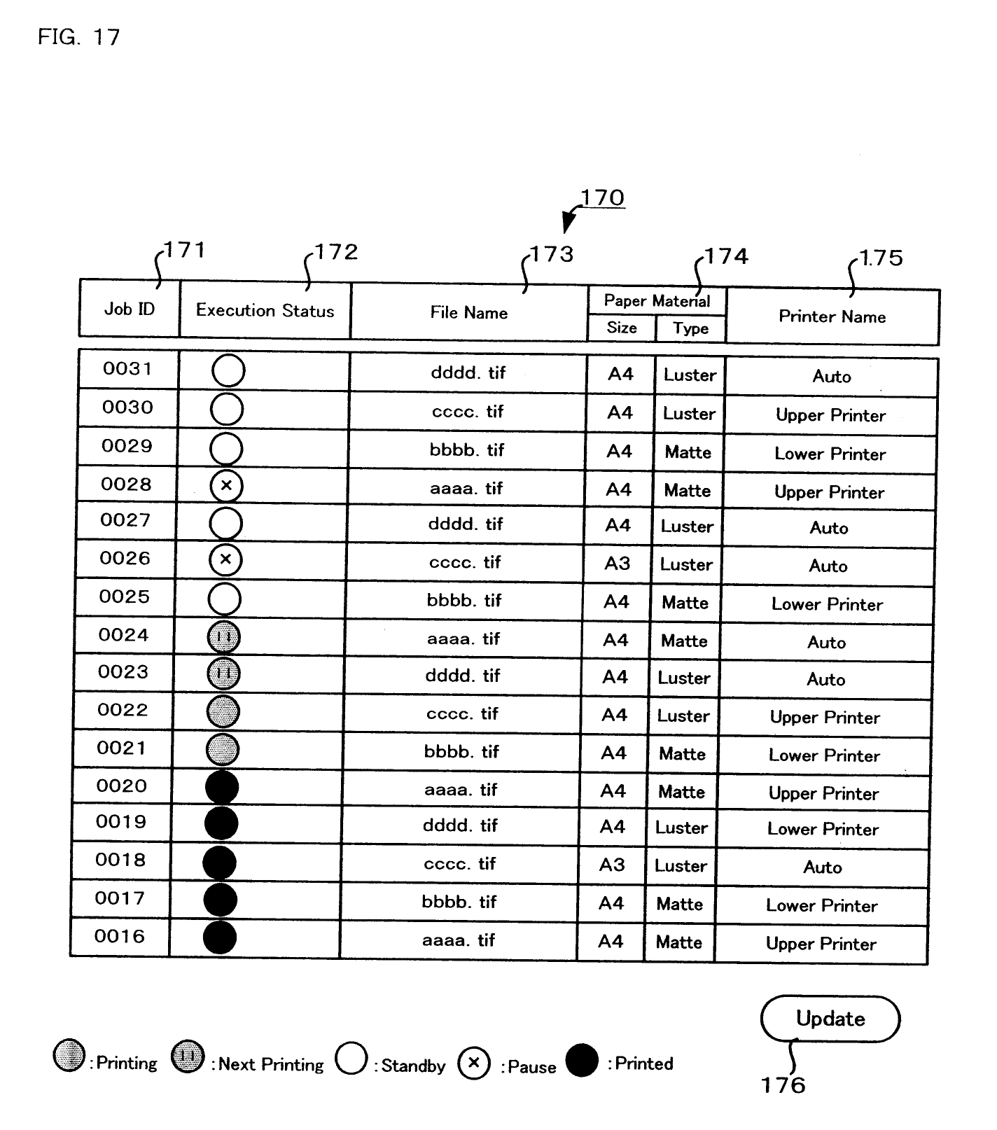

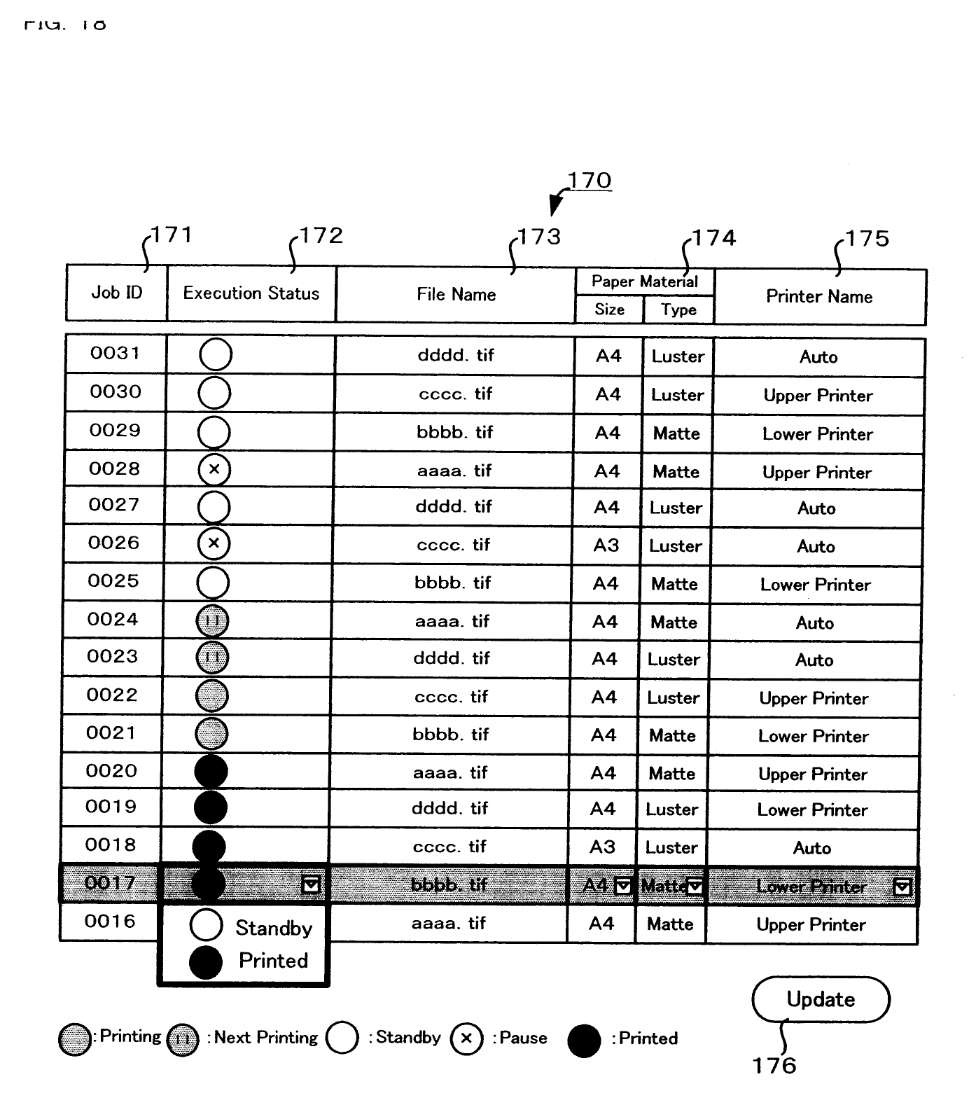

FIG. 17 shows an example of the job execution status display window 170. As illustrated, the job execution status display window 170 includes a job ID display box 171 to show a job ID, an execution status display box 172 to show the status of each print job, a file name display box 173 to show the file name of the image data included in each print job, a paper material display box 174 to show the size and the type of printing paper selected for each print job, a printer name display box 175 to show the name of the printer specified for printing, and an ‘Update’ button 176 to accept a selective input. For the better comprehension of the illustration of the job execution status display window 170, different marks respectively corresponding to ‘Printing’ or the printing state, ‘Next Printing’ or the distributed state, ‘Standby’ or the standby state, ‘Pause’ or the pause state, and ‘Printed’ or the printed state are used to show the execution statues of the respective print jobs in the execution status display box 172. In the actual structure of the embodiment, color marks are used to allow discrimination, for example, a blinking green mark for ‘Printing’, a green mark for ‘Next Printing’, a yellow mark for ‘Standby’, an orange mark for ‘Pause’, and a black mark for ‘Printed’. In the job execution status display window 170, for the better comprehension of the specified printer, the printer 150a located on the upper layer in the system and the printer 150b located below the printer 150a are respectively expressed as ‘Upper Printer’ and ‘Lower Printer’ in the printer name display box 175. No specification of the printer for printing is expressed as ‘Auto’ in the printer name display box 175.

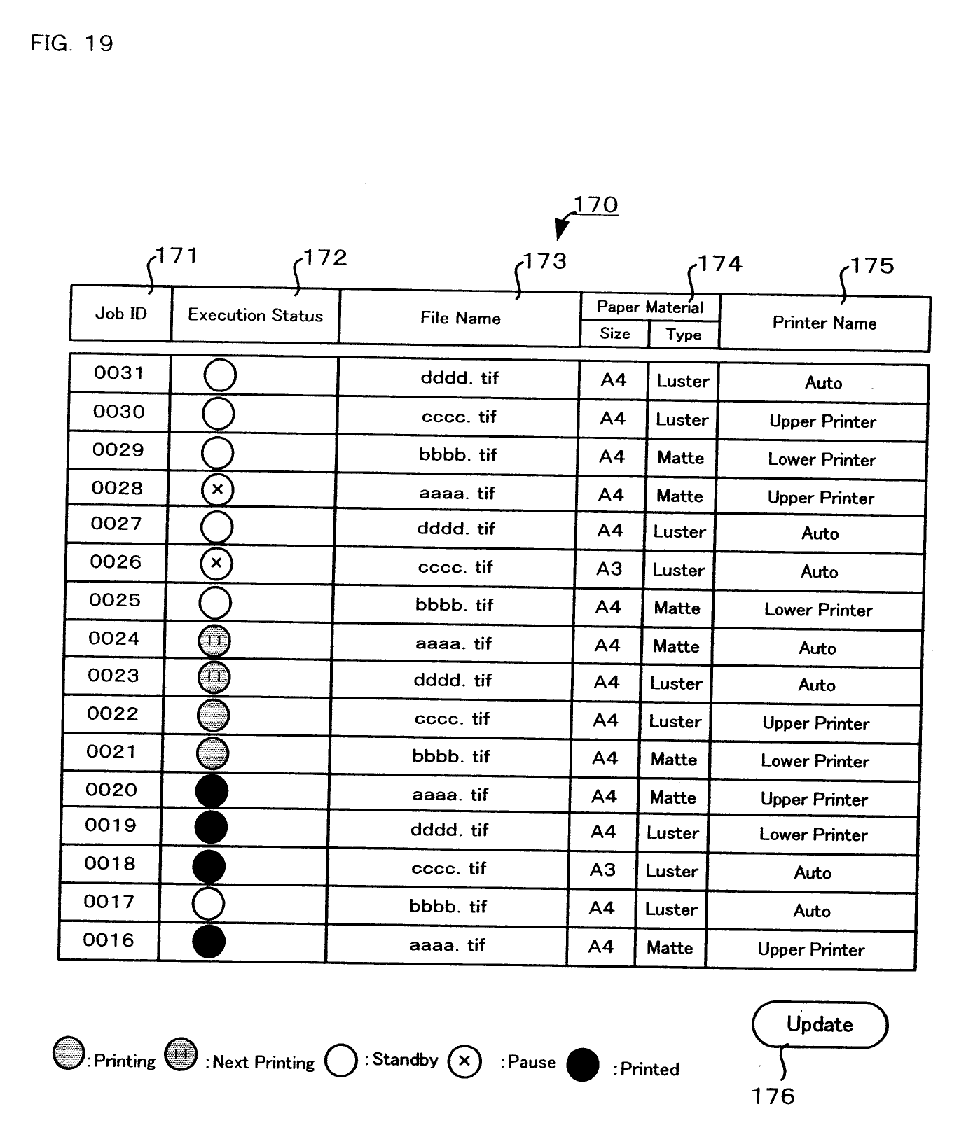

The print job re-execution routine is executed, in response to selection of a print job, for example, by a click with a mouse, in the job execution status display window 70 displayed on the job monitor 138 or the client computer 120a or 120b. As shown in FIG. 16, the print job re-execution routine first makes the respective display boxes of a selected print job active (step S1160), and displays a pull-down menu in the active execution status display box to wait for a selective input of the standby state (step S1162). FIG. 18 shows an example of the selective input window to wait for a selective input of the standby state. In this example, a job ID ‘0017’ is selected, and the pull-down menu is open in the execution status display box 172 to wait for a selective input of the standby state. Specification or change of the printer used for printing in the printer name display box 175 and change of the size and the type of printing paper in the paper material display box 174 may also be selectively input from the respective pull-down menus. The selective input is accepted by an operation of the ‘Update’ button 176. When the standby state is selectively input from the pull-down menu and the selective input is accepted by an operation of the ‘Update’ button 176, the routine changes the status of the selected print job from the printed state to the standby state (step S1164). The program then exits from this print job re-execution routine. Like the other print jobs in the standby state, the print job changed to the standby state is an object of the print job status setting routine shown in FIG. 13, the print job distribution routine shown in FIG. 14, and the job execution status output routine and is executed by either of the printers 150a and 150b. FIG. 19 shows the job execution status display window 170 including the print job set to the standby state by the print job re-execution routine. In this example, the settings of the selected print job have been changed to the standby state in the execution status display box 172, from ‘Matte’ to ‘Luster’ in the type of the paper material display box 174, and from ‘Lower Printer’ to ‘Auto’ in the printer name display box 75.

As discussed above, in the print server 130 of the second embodiment, when there is a vacancy in either of the printer spoolers 144a and 144b, a print job having the printing conditions coincident with the paper material and the ink currently set in the corresponding printer, which receives print data from the vacant printer spooler, among print jobs in the standby state is distributed to the printer. This arrangement enables multiple print jobs to be efficiently executed by the two printers 150a and 150b. After distribution of the print job to the printer, the image data are subjected to color correction and conversion into CMYK color data. This ensures output of appropriate color images, even when the printers 150a and 150b require different processes of color correction.

In the print server 130 of the second embodiment, when a print job held in the job spooler 136 has printing conditions different from any of the paper materials and the inks currently set in the printers 150a and 150b, the print job is set in the pause state until a change of the setting conditions to those coincident with the printing conditions. In this case, subsequently input print jobs in the standby state are executed prior to execution of this print job in the pause state. Compared with the system of executing print jobs in the input order without any exception, this arrangement desirably reduces the frequency of replacement of the paper material and the ink set in the printers 150a and 150b and thereby ensures efficient execution of the print jobs.

In the print server 130 of the second embodiment, the printing conditions of each print job may include specification of a desired printer used for printing, so that the print job is executed by the desired printer.

In the print server 130 of the second embodiment, the execution status of each print job is output in the job execution status display window 70 displayed as a Web page. The operator can thus check the execution status of each print job on the client computer 120a or 120b or the job monitor 138. The operator is allowed to change the status of a selected print job from the printed state to the standby state in the job execution status display window 70. The selected print job is thus executed again without transmission of the same print job again from the client computer 120a or 120b. At this moment, the specification of the printer and the settings of the printer including the paper material may also be changed. An identical image can thus be printed again under desired printing conditions by a desired printer.

In the print server 130 of the second embodiment, each of the printer spoolers 144a and 144b is capable of holding two print data including print data being currently printed. This is, however, not restrictive at all and the number of storable print data may be three or more. In such cases, the print job distribution process may distribute a print job preferentially to the printer having the smaller number of print jobs between the numbers of the print jobs Na and Nb held in the printer spoolers. This arrangement ensures quicker execution of print jobs.

The print server 130 of the second embodiment uses the two printers 150a and 150b to execute print jobs. This is, however, not restrictive at all and print jobs may be executed by three or more printers. The print server 130 of this embodiment receives print jobs transmitted from the two client computers 120a and 120b. This is, however, not restrictive at all and the number of client computers may be only one or three or more. In the illustration of FIG. 1, only one print server 130 is connected to the LAN 122. This is, however, not restrictive at all and two or more print servers 130 may be connected to the LAN 122. The print server 130 is connected with the client computers 120a and 120b via the LAN 122 in the print server 130 of this embodiment, but the connection may be established by any other communication network.

The print server 130 of the second embodiment generates the job execution status display window 170 as a Web page to be output to and displayed on the job monitor 138 and the client computers 120a and 120b. One possible modification may generate the job execution status display window 170 in a form other than the Web page. Another possible modification may output the job execution status display window 170 to only either the job monitor 138 or the client computer 120a or 120b. Output of the execution status of each print job is not essential and may be omitted if not required.

The print server 130 of the second embodiment utilizes the job execution status display window 170 for the print job re-execution process. The print job re-execution process may, however, be executed without using the job execution status display window 70. In the print server 130 of the second embodiment, specification or change of the printer used for printing and change of the size and the type of the printing paper are allowed in the print job re-execution process. Such specification or change may, however, not be allowed. The print job re-execution process carried out by the print server 130 of the second embodiment is not essential and may be omitted if not required.

The above embodiments are to be considered in all aspects as illustrative and not restrictive. There may be many modifications, change, and alterations without departing from the scope or spirit of the main characteristics of the present invention. All changes within the meaning and range of equivalency of the claims are therefore intended to be embraced therein.

What is claimed is:

1. A printing system where a print job output device that outputs a print job is connected via a communication line with a print job execution device that is equipped with a printer,
said print job output device comprising: a storage module that stores information on multiple paper materials settable in said printer of said print job execution device as multiple settable paper materials and information on a paper material currently set in said printer of said print job execution device as a setting paper material; a paper material selection module that selects a printing paper material used for printing among the multiple settable paper materials; a print job generation module that generates a print job of printing object print data on the selected printing paper material, whether the printing paper material is coincident with or different from the currently set paper material; and a print job output module that outputs the generated print job to said print job execution device,
said print job execution device comprising: a setting paper material storage module that stores information on the paper material currently set in said printer as the setting paper material; a print job accept module that accepts the print job of printing the object print data on the printing paper material selected as the paper material used for printing, which is output from said print job output device; a print job holder module that holds the accepted print job as a currently processible print job in the case where the printing paper material selected for the print job is coincident with the setting paper material and holds the accepted print job as a currently non-processible print job in the case where the printing paper material selected for the print job is different from the setting paper material, said print job holder module, in response to a replacement of the setting paper material, holding a print job, which has a selected paper material coincident with the replaced setting paper material, among the print jobs held therein as a currently processible print job and holding a print job, which has a selected paper material different from the replaced setting paper material, among the print jobs held therein as a currently non-processible print job; and a print job execution module that causes said printer to execute the currently processible print job among the print jobs held in said print job holder module.

2. A printing system in accordance with claim 1, wherein said print job generation module of said print job output device acquires status information, which includes information on the setting paper material currently set in said printer, from said print job execution device via the communication line, notifies incapable processing information representing that a print job to be generated is currently non-processible when the selected printing paper material is different from the setting paper material, and generates the print job in response to an approval for the notification of the incapable processing information.

3. A printing system in accordance with claim 1, wherein said print job output device further comprises a paper material information acquisition module that acquires information on the multiple settable paper materials and the setting paper material from said print job execution device via the communication line, and said storage module stores the information on the multiple settable paper materials and the setting paper material acquired by said paper material information acquisition module.

4. A printing system in accordance with claim 1, wherein said paper material selection module of said print job output device selects a paper size and a paper quality among the multiple settable paper materials on a layout editing window of the object print data, thereby selecting the printing paper material.

5. A printing system in accordance with claim 1, wherein said setting paper material storage module of said print job execution device updates the information on the setting paper material in response to every replacement of the setting paper material currently set in said printer.

6. A printing system in accordance with claim 1, wherein said print job execution device further comprises a job status display module that displays a status of a print job held in said print job holder module.

7. A printing system in accordance with claim 6, wherein said job status display module of said print job execution device displays the printing paper material selected for the print job, in addition to the status of the print job.

8. A printing system in accordance with claim 6, wherein said job status display module of said print job execution device displays the status of the print job that is currently being executed by said print job execution module.

9. A printing system in accordance with claim 6, wherein said job status display module of said print job execution device updates information to be displayed at regular intervals.

10. A printing system where a print job output device that outputs a print job is connected via a communication line with a print job execution device that has multiple printers, each printer accepting a preset number of print jobs having a printing condition coincident with a setting condition therein and successively executing the accepted print jobs,
said print job output device comprising: a storage module that stores information on multiple paper materials settable in said multiple printers of said print job execution device as multiple settable paper materials and information on a paper material currently set in each of said multiple printers of said print job execution device as a setting paper material; a paper material selection module that selects a printing paper material used for printing among the multiple settable paper materials; a print job generation module that generates a print job of printing object print data on the selected printing paper material, whether the printing paper material is coincident with or different from any setting paper material; and a print job output module that outputs the generated print job to said print job execution device,
said print job execution device comprising: a job input module that inputs print jobs having printing conditions; an accepted job number detection module that detects a number of print jobs accepted by each of said multiple printers; a condition storage module that stores a setting condition set in each of said multiple printers; and a job distribution module that distributes a certain print job, which has not yet been accepted by any of said multiple printers, among the print jobs input by said job input module, to one of said multiple printers for acceptance, based on the numbers of print jobs accepted respectively by said multiple printers and detected by said accepted job number detection module, the setting conditions set respectively in said multiple printers and stored in said condition storage module, and the printing condition of the certain print job input by said job input module.

11. A printing system in accordance with claim 10, wherein said print job generation module of said print job output device acquires status information, which includes information on the setting paper material currently set in said printer, from said print job execution device via the communication line, notifies incapable processing information representing that a print job to be generated is currently non-processible when the selected printing paper material is different from the setting paper material, and generates the print job in response to an approval for the notification of the incapable processing information.

12. A printing system in accordance with claim 10, wherein said print job output device further comprises a paper material information acquisition module that acquires information on the multiple settable paper materials and the setting paper material from said print job execution device via the communication line, and said storage module stores the information on the multiple settable paper materials and the setting paper material acquired by said paper material information acquisition module.

13. A printing system in accordance with claim 10, wherein said paper material selection module of said print job output device selects a paper size and a paper quality among the multiple settable paper materials on a layout editing window of the object print data, thereby selecting the printing paper material.

14. A printing system in accordance with claim 10, wherein said job distribution module of said print job execution device distributes the certain print job, when any of the numbers of print jobs accepted respectively by said multiple printers and detected by said accepted job number detection module is less than the preset number.

15. A printing system in accordance with claim 10, wherein said job distribution module of said print job execution device distributes the certain print job to a printer having a less number of the accepted print jobs, when the setting conditions set in plural printers are coincident with the printing condition of the certain print job.

16. A printing system in accordance with claim 10, wherein said print job execution device further comprises a job processing status output module that outputs each of the print jobs input by said job input module in a discriminative manner to allow discrimination among a print job in a status of not being accepted by any of said multiple printers, a print job in a status of being accepted by any of said multiple printers but not being executed, a print job in a status of being currently executed by any of said multiple printers, and a print job in a status of completed execution by any of said multiple printers.

17. A printing system in accordance with claim 10, wherein said print job execution device further comprises a distribution reservation module that reserves the distribution of a specific print job by said job distribution module until a setting condition coincident with the printing condition is set in any of said multiple printers, in the case where the printing condition of the specific print job input by said job input module is not coincident with any of the setting conditions set respectively in said multiple printers and stored in said condition storage module,.

18. A printing system in accordance with claim 17, wherein said print job execution device further comprises a job processing status output module that outputs each of the print jobs input by said job input module in a discriminative manner to allow discrimination among a print job in a status of not being accepted by any of said multiple printers, a print job in a status of being accepted by any of said multiple printers but not being executed, a print job in a status of being currently executed by any of said multiple printers, a print job in a status of completed execution by any of said multiple printers, and a print job in a status of reserved distribution by said distribution reservation module.

19. A printing system in accordance with claim 10, wherein said job input module of said print job execution device inputs the print job with specification of a printer to execute printing among said multiple printers as one of printing conditions, and
said job distribution module of said print job execution device distributes the print job with specification of the printer to execute printing as one of printing conditions to said specified printer in distributing the print job.

20. A printing system in accordance with claim 10, wherein said print job execution device further comprises a job processing status change module that changes a print job in a status of completed execution by any of said multiple printers to a print job in a status of not being accepted by any of said multiple printers.

21. A printing system in accordance with claim 10, wherein each of said multiple printers included in said print job execution device accepts and successively executes print jobs, which have been subjected to a printing process of converting image data into print data printable by said printer, and
said job distribution module of said print job execution device makes the certain print job subjected to the printing process, prior to distribution.

22. A printing system in accordance with claim 21, wherein said print job execution device further comprises a color correction data storage module that stores color correction data with regard to each of said multiple printers, and
said job distribution module of said print job execution device carries out color correction of the image data, as one of the printing process, with color correction data of said printer to which the certain print job is distributed, among the color correction data stored in said color correction data storage module.

23. A print job output device that is connected via a communication line with a print job execution device having at least one printer, said print job output device comprising:
a storage module that stores information on multiple paper materials settable in said printer of said print job execution device as multiple settable paper materials and information on a paper material currently set in said printer of said print job execution device as a setting paper material;
a paper material selection module that selects a printing paper material used for printing among the multiple settable paper materials;
a print job generation module that generates a print job of printing object print data on the selected printing paper material, whether the printing paper material is coincident with or different from the currently set paper material; and
a print job output module that outputs the generated print job to said print job execution device,

24. A print job output device in accordance with claim 23, wherein said print job generation module, when the selected printing paper material is different from the setting paper material, notifies incapable processing information representing that a print job to be generated is currently non-processible and generates the print job in response to an approval for the notification of the incapable processing information.

25. A print job output device in accordance with claim 23, wherein said print job generation module acquires status information, which includes information on the setting paper material currently set in said printer, from said print job execution device via the communication line, and shows the incapable processing information on a display for the notification, based on the acquired status information.

26. A print job output device in accordance with claim 23, wherein said print job generation module, when the selected printing paper material is different from the setting paper material, notifies auto processing information, which represents that a print job to be generated is currently non-processible but will be automatically processed when the printing paper material is set in said printer and generates the print job in response to an approval for the notification of the auto processing information.

27. A print job output device in accordance with claim 26, wherein sad print job generation module acquires status information, which includes information on the setting paper material currently set in said printer, from said print job execution device via the communication line, and shows the auto processing information on a display for the notification, based on the acquired status information.

28. A print job output device in accordance with claim 23, said print job output device further comprising a settable paper material information acquisition module that acquires information on the multiple settable paper materials from said print job execution device via the communication line,
wherein said storage module stores the information on the multiple settable paper materials acquired by said settable paper material information acquisition module.

29. A print job output device in accordance with claim 23, said print job output device further comprising a setting paper material information acquisition module that acquires information on the setting paper material from said print job execution device via the communication line,
wherein said storage module stores the information on the setting paper material acquired by said setting paper material information acquisition module.

30. A print job output device in accordance with claim 29, wherein said setting paper material information acquisition module acquires the information on the setting paper material at regular intervals from said print job execution device via the communication line.

31. A print job output device in accordance with claim 23, wherein said paper material selection module selects a paper size and a paper quality among the multiple settable paper materials, thereby selecting the printing paper material.

32. A print job output device in accordance with claim 23, wherein said paper material selection module selects the printing paper material on a layout editing window of the object print data.

33. A method of outputting a print job to a print job execution device having at least one printer, said method comprising the steps of:
(a) storing information on multiple paper materials settable in said printer of said print job execution device as multiple settable paper materials and information on a paper material currently set in said printer of said print job execution device as a setting paper material;
(b) selecting a printing paper material used for printing among the multiple settable paper materials;
(c) generatings a print job of printing object print data on the selected printing paper material, whether the printing paper material is coincident with or different from the currently set paper material; and
(d) outputting the generated print job to said print job execution device,

34. A method in accordance with claim 33, wherein said step (c) acquires status information, which includes information on the setting paper material currently set in said printer, from said print job execution device, notifies incapable processing information representing that a print job to be generated is currently non-processible when the selected printing paper material is different from the setting paper material, and generates the print job in response to an approval for the notification of the incapable processing information.

35. A method in accordance with claim 33, wherein said step (a) acquires information on the multiple settable paper materials and the setting paper material from said print job execution device and stores the acquired information on the multiple settable paper materials and the setting paper material.

36. A method in accordance with claim 33, wherein said step (b) selects a paper size and a paper quality among the multiple settable paper materials on a layout editing window of the object print data, thereby selecting the printing paper material.

37. A print job execution device that is connected with a print job output device via a communication line, said print job execution device comprising:
at least one printer;
a setting paper material storage module that stores information on a paper material currently set in said printer as setting paper material;
a print job accept module that accepts a print job of printing object print data on a printing paper material selected as a paper material used for printing, which is output from said print job output device;
a print job holder module that holds the accepted print job as a currently processible print job in the case where the printing paper material selected for the print job is coincident with the setting paper material and holds the accepted print job as a currently non-processible print job in the case where the printing paper material selected for the print job is different from the setting paper material, said print job holder module, in response to a replacement of the setting paper material, holding a print job, which has a selected paper material coincident with the replaced setting paper material, among the print jobs held therein as a currently processible print job and holding a print job, which has a selected paper material different from the replaced setting paper material, among the print jobs held therein as a currently non-processible print job; and
a print job execution module that causes said printer to execute the currently processible print job among the print jobs held in said print job holder module.

38. A print job execution device in accordance with claim 37, wherein said setting paper material storage module updates the information on the setting paper material in response to every replacement of the setting paper material currently set in said printer.

39. A print job execution device in accordance with claim 37, said print job execution device further comprising:
a job status display module that displays a status of a print job held in said print job holder module.

40. A print job execution device in accordance with claim 39, wherein said job status display module displays the printing paper material selected for the print job, in addition to the status of the print job.

41. A print job execution device in accordance with claim 40, wherein said job status display module displays a paper size and a paper quality as the information on the printing paper material.

42. A print job execution device in accordance with claim 39, wherein said job status display module displays the status of the print job that is currently being executed by said print job execution module.

43. A print job execution device in accordance with claim 39, wherein said job status display module updates information to be displayed at regular intervals.

44. A method of causing a printer to execute a print job output from a print job output device, said method comprising the steps of:
(a) storing information on a paper material currently set in said printer as setting paper material;
(b) accepting a print job of printing object print data on a printing paper material selected as a paper material used for printing, which is output from said print job output device;
(c) holding the accepted print job as a currently processible print job in the case where the printing paper material selected for the print job is coincident with the setting paper material and holding the accepted print job as a currently non-processible print job in the case where the printing paper material selected for the print job is different from the setting paper material, said step (c),in response to a replacement of the setting paper material, holding a print job, which has a selected paper material coincident with the replaced setting paper material, among the print jobs held therein as a currently processible print job and holding a print job, which has a selected paper material different from the replaced setting paper material, among the print jobs held therein as a currently non-processible print job; and
(d) causing said printer to execute the currently processible print job among the print jobs held in said print job holder module.

45. A method in accordance with claim 44, wherein said step (a) updates and stores the information on the setting paper material in response to every replacement of the setting paper material currently set in said printer.

46. A method in accordance with claim 44, said method further comprising the step of:
(e) displaying a status of a print job held in said step (c).

47. A method in accordance with claim 46, wherein said step (e) displays the printing paper material selected for the print job, in addition to the status of the print job.

48. A method in accordance with claim 46, wherein said step (e) displays the status of the print job that is currently being executed in said step (d).

49. A method in accordance with claim 46, wherein said step (e) updates information to be displayed at regular intervals.

50. A print job execution device that has multiple printers, said print job execution device causing each of said multiple printers to accept a preset number of print jobs having a printing condition coincident with a setting condition therein and successively execute the accepted print jobs, said print job execution device comprising:
a job input module that inputs print jobs having printing conditions;
an accepted job number detection module that detects a number of print jobs accepted by each of said multiple printers;
a condition storage module that stores a setting condition set in each of said multiple printers; and
a job distribution module that distributes a certain print job, which has not yet been accepted by any of said multiple printers, among the print jobs input by said job input module, to one of said multiple printers for acceptance, based on the numbers of print jobs accepted respectively by said multiple printers and detected by said accepted job number detection module, the setting conditions set respectively in said multiple printers and stored in said condition storage module, and the printing condition of the certain print job input by said job input module.

51. A print job execution device in accordance with claim 50, wherein said job distribution module distributes the certain print job, when any of the numbers of print jobs accepted respectively by said multiple printers and detected by said accepted job number detection module is less than the preset number.

52. A print job execution device in accordance with claim 50, wherein said job distribution module distributes the certain print job to a printer having a less number of the accepted print jobs, when the setting conditions set in plural printers are coincident with the printing condition of the certain print job.

53. A print job execution device in accordance with claim 50, wherein said job distribution module distributes the print jobs input by said job input module in an input order.

54. A print job execution device in accordance with claim 50, said print job execution device further comprising a job processing status output module that outputs a status of each print job input by said job input module.

55. A print job execution device in accordance with claim 54, wherein said job processing status output module device outputs each of the input print jobs in a discriminative manner to allow discrimination among a print job in a status of not being accepted by any of said multiple printers, a print job in a status of being accepted by any of said multiple printers but not being executed, a print job in a status of being currently executed by any of said multiple printers, and a print job in a status of completed execution by any of said multiple printers.

56. A print job execution device in accordance with claim 50, said print job execution device further comprising a distribution reservation module that reserves the distribution of a specific print job by said job distribution module until a setting condition coincident with the printing condition is set in any of said multiple printers, in the case where the printing condition of the specific print job input by said job input module is not coincident with any of the setting conditions set respectively in said multiple printers and stored in said condition storage module,.

57. A print job execution device in accordance with claim 56, said print job execution device further comprising a job processing status output module that outputs each of the print jobs input by said job input module in a discriminative manner to allow discrimination among a print job in a status of not being accepted by any of said multiple printers, a print job in a status of being accepted by any of said multiple printers but not being executed, a print job in a status of being currently executed by any of said multiple printers, a print job in a status of completed execution by any of said multiple printers, and a print job in a status of reserved distribution by said distribution reservation module.

58. A print job execution device in accordance with claim 50, wherein said job input module inputs the print job with specification of a printer to execute printing among said multiple printers as one of printing conditions, and
said job distribution module distributes the print job with specification of the printer to execute printing as one of printing conditions to said specified printer.

59. A print job execution device in accordance with claim 50, said print job execution device further comprising a job processing status change module that changes a print job in a status of completed execution by any of said multiple printers to a print job in a status of not being accepted by any of said multiple printers.

60. A print job execution device in accordance with claim 50, wherein each of said multiple printers accepts and successively executes print jobs, which have been subjected to a predetermined process suitable for said printer, and
said job distribution module makes the certain print job subjected to the predetermined process, prior to distribution.

61. A print job execution device in accordance with claim 60, wherein the predetermined process includes conversion of image data into print data printable by said printer.

62. A print job execution device in accordance with claim 61, said print job execution device further comprising:
a color correction data storage module that stores color correction data with regard to each of said multiple printers,
wherein said job distribution module carries out color correction of the image data, as one of the predetermined process, with color correction data of said printer to which the certain print job is distributed, among the color correction data stored in said color correction data storage module.

63. A print job execution device in accordance with claim 50, wherein the preset number is equal to a value 2 including a print job currently being printed.

64. A method of causing each of multiple printers to accept a preset number of print jobs having a printing condition coincident with a setting condition therein and successively execute the accepted print jobs, said method comprising the steps of:
(a) inputting print jobs having printing conditions;
(b) detecting a number of print jobs accepted by each of said multiple printers;
(c) storing a setting condition set in each of said multiple printers; and
(d) distributing a certain print job, which has not yet been accepted by any of said multiple printers, among the input print jobs, to one of said multiple printers for acceptance, based on the detected numbers of print jobs accepted respectively by said multiple printers, the stored setting conditions set respectively in said multiple printers, and the printing condition of the certain print job.

65. A method in accordance with claim 64, wherein said step (d) distributes the certain print job, when any of the numbers of print jobs accepted respectively by said multiple printers and detected by said accepted job number detection module is less than the preset number.

66. A method in accordance with claim 64, wherein said step (d) distributes the certain print job to a printer having a less number of the accepted print jobs, when the setting conditions set in plural printers are coincident with the printing condition of the certain print job.

67. A method in accordance with claim 64, said method further comprising the step of:
outputting each of the input print jobs in a discriminative manner to allow discrimination among a print job in a status of not being accepted by any of said multiple printers, a print job in a status of being accepted by any of said multiple printers but not being executed, a print job in a status of being currently executed by any of said multiple printers, and a print job in a status of completed execution by any of said multiple printers.

68. A method in accordance with claim 64, wherein said step (d) reserves the distribution of a specific print job until a setting condition coincident with the printing condition is set in any of said multiple printers, in the case where the printing condition of the input specific print job is not coincident with any of the stored setting conditions set respectively in said multiple printers,.

69. A method in accordance with claim 68, said method further comprising the step of:
outputting each of the input print jobs in a discriminative manner to allow discrimination among a print job in a status of not being accepted by any of said multiple printers, a print job in a status of being accepted by any of said multiple printers but not being executed, a print job in a status of being currently executed by any of said multiple printers, a print job in a status of completed execution by any of said multiple printers, and a print job in a status of reserved distribution by said distribution reservation module.

70. A method in accordance with claim 64, wherein said step (a) inputs the print job with specification of a printer to execute printing among said multiple printers as one of printing conditions, and
said step (d) distributes the print job with specification of the printer to execute printing as one of printing conditions to said specified printer.

71. A method in accordance with claim 64, said method further comprising the step of:
changing a print job in a status of completed execution by any of said multiple printers to a print job in a status of not being accepted by any of said multiple printers.

72. A method in accordance with claim 64, wherein said step (d) makes the certain print job subjected to a printing process of converting the image data into print data printable by any of said multiple printers, prior to the distribution.

73. A method in accordance with claim 72, wherein said step (d) carries out color correction of the image data, as one of the printing process, with color correction data of said printer to which the certain print job is distributed.
